(19) United States
(12) Patent Application Publication
(10) Pub. No.: US 2026/0214197 A1
(43) Pub. Date: Jul. 23, 2026

(54) MULTI-VIEW BASED EYEBALL FITTING FOR SINGLE VIEW GAZE PREDICTION

(71) Applicant: QUALCOMM Incorporated, San Diego, CA (US)

(72) Inventors: Andrea Francesco CORTESI, Ludon-Médoc (FR); Said BENHA, Bordeaux (FR); Ophir PAZ, Floirac (FR); Thomas SOULE, Bruges (FR)

(21) Appl. No.: 19/277,198

(22) Filed: Jul. 22, 2025

Related U.S. Application Data
(60) Provisional application No. 63/746,884, filed on Jan. 17, 2025.

(51) Int. Cl. H04N 13/383; G06V 10/62; G06V 10/77; G06V 20/20; G06V 40/18; H04N 13/221; H04N 13/282

(52) U.S. Cl. CPC H04N 13/383; G06V 10/62; G06V 10/7715; G06V 20/20; G06V 40/193; H04N 13/221; H04N 13/282

(57) ABSTRACT

Systems and techniques are described for extended reality (XR). For example, a computing device can extract, using an encoder of a machine learning model, features from an image comprising an eye of a user wearing an XR device. The computing device can process, using a decoder of the machine learning model, the features to generate ellipse parameters associated with a pupil of the eye of the user. The computing device can generate, based on the ellipse parameters, an ellipse contour associated with the pupil of the eye of the user.

### CROSS-REFERENCE TO RELATED APPLICATIONS

This application claims the benefit of U.S. Provisional Patent Application No. 63/746,884, filed Jan. 17, 2025, which is hereby incorporated by reference, in its entirety and for all purposes.

### FIELD

The present disclosure generally relates to extended reality. For example, aspects of the present disclosure relate to system designs and methods for a multi-view based eyeball fitting for a single view gaze prediction.

### BACKGROUND

An extended reality (XR) (e.g., including virtual reality, augmented reality, and/or mixed reality) system can provide a user with a virtual experience by immersing the user in a completely virtual environment (made up of virtual content) and/or can provide the user with an augmented or mixed reality experience by combining a real-world or physical environment with a virtual environment.

One example use case for XR content that provides virtual, augmented, or mixed reality to users is to present a user with a “metaverse” experience. The metaverse is essentially a virtual universe that includes one or more three-dimensional (3D) virtual worlds. For example, a metaverse virtual environment may allow a user to virtually interact with other users (e.g., in a social setting, in a virtual meeting, etc.), to virtually shop for goods, services, property, or other item, to play computer games, and/or to experience other services. Gaze estimation in XR often aims to determine which icons or elements a user is focusing on. The gaze pose can be used to select elements in the virtual interface or for foveation.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, apparatuses, methods and computer-readable media for extended reality. In some aspects, an apparatus for extended reality (XR) is provided. The apparatus includes at least one memory and at least one processor coupled to the at least one memory and configured to: extract, using an encoder of a machine learning model, features from an image including an eye of a user wearing an XR device; process, using a decoder of the machine learning model, the features to generate ellipse parameters associated with a pupil of the eye of the user; and generate, based on the ellipse parameters, an ellipse contour associated with the pupil of the eye of the user.

In some aspects, a method for extended reality (XR) is provided. The method includes: extracting, by an encoder of a machine learning model, features from an image including an eye of a user wearing an XR device; processing, by a decoder of the machine learning model, the features to generate ellipse parameters associated with a pupil of the eye of the user; and generating, based on the ellipse parameters, an ellipse contour associated with the pupil of the eye of the user.

In some aspects, a non-transitory computer-readable medium having stored thereon instructions that, when executed by at least one processor, cause the at least one processor to: extract, using an encoder of a machine learning model, features from an image including an eye of a user wearing an XR device; process, using a decoder of the machine learning model, the features to generate ellipse parameters associated with a pupil of the eye of the user; and generate, based on the ellipse parameters, an ellipse contour associated with the pupil of the eye of the user.

In some aspects, an apparatus for extended reality (XR) is provided. The apparatus includes: means for extracting features from an image including an eye of a user wearing an XR device; means for processing the features to generate ellipse parameters associated with a pupil of the eye of the user; and means for generating, based on the ellipse parameters, an ellipse contour associated with the pupil of the eye of the user.

In some aspects, an apparatus for extended reality (XR) is provided. The apparatus includes at least one memory and at least one processor coupled to the at least one memory and configured to: obtain a first two-dimensional (2D) image at a first pose of an XR device; unproject a first ellipse contour on the first 2D image into a three-dimensional (3D) space to generate a first cone; obtain a second 2D image at a second pose of the XR device; unproject a second ellipse contour on the second 2D image into the 3D space to generate a second cone, wherein the first ellipse contour and the second ellipse contour are associated with a pupil of an eye of a user wearing the XR device; and determine, based on an intersection of the first cone and the second cone, a location of a center of the pupil of the eye of the user.

In some aspects, a method for extended reality (XR) is provided. The method includes: obtaining a first two-dimensional (2D) image at a first pose of an XR device; unprojecting a first ellipse contour on the first 2D image into a three-dimensional (3D) space to generate a first cone; obtaining a second 2D image at a second pose of the XR device; unprojecting a second ellipse contour on the second 2D image into the 3D space to generate a second cone, wherein the first ellipse contour and the second ellipse contour are associated with a pupil of an eye of a user wearing the XR device; and determining, based on an intersection of the first cone and the second cone, a location of a center of the pupil of the eye of the user.

In some aspects, a non-transitory computer-readable medium having stored thereon instructions that, when executed by at least one processor, cause the at least one processor to: obtain a first two-dimensional (2D) image at a first pose of an XR device; unproject a first ellipse contour on the first 2D image into a three-dimensional (3D) space to generate a first cone; obtain a second 2D image at a second pose of the XR device; unproject a second ellipse contour on the second 2D image into the 3D space to generate a second cone, wherein the first ellipse contour and the second ellipse contour are associated with a pupil of an eye of a user wearing the XR device; and determine, based on an intersection of the first cone and the second cone, a location of a center of the pupil of the eye of the user.

In some aspects, an apparatus for extended reality (XR) is provided. The apparatus includes: means for obtaining a first two-dimensional (2D) image at a first pose of an XR device; means for unprojecting a first ellipse contour on the first 2D image into a three-dimensional (3D) space to generate a first cone; means for obtaining a second 2D image at a second pose of the XR device; means for unprojecting a second ellipse contour on the second 2D image into the 3D space to generate a second cone, wherein the first ellipse contour and the second ellipse contour are associated with a pupil of an eye of a user wearing the XR device; and means for determining, based on an intersection of the first cone and the second cone, a location of a center of the pupil of the eye of the user.

In some aspects, an apparatus for extended reality (XR) is provided. The apparatus includes at least one memory and at least one processor coupled to the at least one memory and configured to: determine, based on a respective normal vector for each contour of a plurality of contours, an intersection of the respective normal vectors, wherein each contour of the plurality contours is associated with a respective gaze of a pupil of an eyeball of a user wearing an XR device; and determine, based on the intersection of the respective normal vectors, a center of the eyeball of the user.

In some aspects, a method for extended reality (XR) is provided. The method includes: determining, based on a respective normal vector for each contour of a plurality of contours, an intersection of the respective normal vectors, wherein each contour of the plurality contours is associated with a respective gaze of a pupil of an eyeball of a user wearing an XR device; and determining, based on the intersection of the respective normal vectors, a center of the eyeball of the user.

In some aspects, a non-transitory computer-readable medium having stored thereon instructions that, when executed by at least one processor, cause the at least one processor to: determine, based on a respective normal vector for each contour of a plurality of contours, an intersection of the respective normal vectors, wherein each contour of the plurality contours is associated with a respective gaze of a pupil of an eyeball of a user wearing an XR device; and determine, based on the intersection of the respective normal vectors, a center of the eyeball of the user.

In some aspects, an apparatus for extended reality (XR) is provided. The apparatus includes: means for determining, based on a respective normal vector for each contour of a plurality of contours, an intersection of the respective normal vectors, wherein each contour of the plurality contours is associated with a respective gaze of a pupil of an eyeball of a user wearing an XR device; and means for determining, based on the intersection of the respective normal vectors, a center of the eyeball of the user.

Some aspects include a device having a processor (or multiple processors) configured to perform one or more operations of any of the methods summarized above. In some cases, the processor(s) can include a neural processing unit (NPU), a neural signal processor (NSP), a digital signal processor (DSP), a graphics processing unit (GPU), a central processing unit (CPU), any combination thereof, and/or other processor(s). Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

In some aspects, one or more of the apparatuses described herein is, is part of, and/or includes an extended reality (XR) device or system (e.g., a virtual reality (VR) device, an augmented reality (AR) device, or a mixed reality (MR) device), a mobile device (e.g., a mobile telephone or other mobile device), a wearable device, a wireless communication device, a camera, a personal computer, a laptop computer, a vehicle or a computing device or component of a vehicle, a server computer or server device (e.g., an edge or cloud-based server, a personal computer acting as a server device, a mobile device such as a mobile phone acting as a server device, an XR device acting as a server device, a vehicle acting as a server device, a network router, or other device acting as a server device), another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensor.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a diagram illustrating an example of an extended reality (XR) system in accordance with some aspects of the disclosure.

FIG. 2 is a diagram illustrating an example of a three-dimensional (3D) collaborative virtual environment, in accordance with some aspects of the disclosure.

FIG. 3 is an image with a virtual representation (an avatar) of a user, in accordance with some aspects of the disclosure.

FIG. 4 is a diagram illustrating another example of an XR system, in accordance with some aspects of the disclosure.

FIG. 5 is a diagram illustrating an example configuration of a client device, in accordance with some aspects of the disclosure.

FIG. 6 is a diagram illustrating an example of a normal map, an albedo map, and a specular reflection map, in accordance with some aspects of the disclosure.

FIG. 7 is a diagram illustrating an example of an XR system that performs gaze estimation, in accordance with some aspects of the disclosure.

FIG. 8 is a diagram illustrating an example of processes for a model-based ellipse fitting for a pupil of an eye of a user for gaze estimation, in accordance with some aspects of the disclosure.

FIG. 9 is a diagram illustrating an example of a process for a monocular-view based eyeball fitting of a user for gaze estimation, in accordance with some aspects of the disclosure.

FIG. 10 is a diagram illustrating an example of a process for a multi-view based eyeball fitting of a user for gaze estimation, in accordance with some aspects of the disclosure.

FIG. 11 is a diagram illustrating an example of a process for determining a center of an eyeball of a user for gaze estimation, in accordance with some aspects of the disclosure.

FIG. 12 is a diagram illustrating an example of a process for determining a gaze of a user, in accordance with some aspects of the disclosure.

FIG. 13 illustrates interpupillary distance (IPD) adjustment, in accordance with aspects of the present disclosure.

FIG. 14 is a flow diagram illustrating an example of a process for a multi-view based eyeball fitting for a single view gaze prediction, in accordance with some aspects of the disclosure.

FIG. 15 is a flow diagram illustrating another example of a process for a multi-view based eyeball fitting for a single view gaze prediction, in accordance with some aspects of the disclosure.

FIG. 16 is a flow diagram illustrating yet another example of a process for a multi-view based eyeball fitting for a single view gaze prediction, in accordance with some aspects of the disclosure.

FIG. 17 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

As noted previously, an extended reality (XR) system or device can provide a user with an XR experience by presenting virtual content to the user (e.g., for a completely immersive experience) and/or can combine a view of a real-world or physical environment with a display of a virtual environment (made up of virtual content). The real-world environment can include real-world objects (also referred to as physical objects), such as people, vehicles, buildings, tables, chairs, and/or other real-world or physical objects. As used herein, the terms XR system and XR device are used interchangeably. Examples of XR systems or devices include head-mounted displays (HMDs), smart glasses (e.g., AR glasses, MR glasses, etc.), among others.

XR systems can include virtual reality (VR) systems facilitating interactions with VR environments, augmented reality (AR) systems facilitating interactions with AR environments, mixed reality (MR) systems facilitating interactions with MR environments, and/or other XR systems. For instance, VR provides a complete immersive experience in a three-dimensional (3D) computer-generated VR environment or video depicting a virtual version of a real-world environment. VR content can include VR video in some cases, which can be captured and rendered at very high quality, potentially providing a truly immersive virtual reality experience. Virtual reality applications can include gaming, training, education, sports video, online shopping, among others. VR content can be rendered and displayed using a VR system or device, such as a VR HMD or other VR headset, which fully covers a user's eyes during a VR experience.

AR is a technology that provides virtual or computer-generated content (referred to as AR content) over the user's view of a physical, real-world scene or environment. AR content can include any virtual content, such as video, images, graphic content, location data (e.g., global positioning system (GPS) data or other location data), sounds, any combination thereof, and/or other augmented content. An AR system is designed to enhance (or augment), rather than to replace, a person's current perception of reality. For example, a user can see a real stationary or moving physical object through an AR device display, but the user's visual perception of the physical object may be augmented or enhanced by a virtual image of that object (e.g., a real-world car replaced by a virtual image of a DeLorean), by AR content added to the physical object (e.g., virtual wings added to a live animal), by AR content displayed relative to the physical object (e.g., informational virtual content displayed near a sign on a building, a virtual coffee cup virtually anchored to (e.g., placed on top of) a real-world table in one or more images, etc.), and/or by displaying other types of AR content. Various types of AR systems can be used for gaming, entertainment, and/or other applications.

MR technologies can combine aspects of VR and AR to provide an immersive experience for a user. For example, in an MR environment, real-world and computer-generated objects can interact (e.g., a real person can interact with a virtual person as if the virtual person were a real person).

An XR environment can be interacted with in a seemingly real or physical way. As a user experiencing an XR environment (e.g., an immersive VR environment) moves in the real world, rendered virtual content (e.g., images rendered in a virtual environment in a VR experience) also changes, giving the user the perception that the user is moving within the XR environment. For example, a user can turn left or right, look up or down, and/or move forwards or backwards, thus changing the user's point of view of the XR environment. The XR content presented to the user can change accordingly, so that the user's experience in the XR environment is as seamless as it would be in the real world.

In some cases, an XR system can match the relative pose and movement of objects and devices in the physical world. For example, an XR system can use tracking information to calculate the relative pose of devices, objects, and/or features of the real-world environment in order to match the relative position and movement of the devices, objects, and/or the real-world environment. In some examples, the XR system can use the pose and movement of one or more devices, objects, and/or the real-world environment to render content relative to the real-world environment in a convincing manner. The relative pose information can be used to match virtual content with the user's perceived motion and the spatio-temporal state of the devices, objects, and real-world environment. In some cases, an XR system can track parts of the user (e.g., a hand and/or fingertips of a user) to allow the user to interact with items of virtual content.

XR systems or devices can facilitate interaction with different types of XR environments (e.g., a user can use an XR system or device to interact with an XR environment). One example of an XR environment is a metaverse virtual environment. A user may virtually interact with other users (e.g., in a social setting, in a virtual meeting, etc.), virtually shop for items (e.g., goods, services, property, etc.), to play computer games, and/or to experience other services in a metaverse virtual environment. In one illustrative example, an XR system may provide a 3D collaborative virtual environment for a group of users. The users may interact with one another via virtual representations of the users in the virtual environment. The users may visually, audibly, haptically, or otherwise experience the virtual environment while interacting with virtual representations of the other users.

As mentioned, gaze estimation in XR often aims to determine which icons or elements a user is focusing on. The gaze pose can be used to select elements in the virtual interface or for foveation. In the domain of XR, one of the key challenges is to develop a pupil-based gaze estimation system that is both accurate and efficient. To achieve high accuracy, solutions often require significant computational time and correlatively power, making them less optimal. Conversely, highly optimized solutions tend to compromise on accuracy. The challenge lies in finding a good trade-off between these factors to ensure both efficiency and precision.

As such, improved systems and techniques for gaze estimation in an XR system that are accurate in performance as well as efficient in terms of computational time and power can be beneficial.

In one or more aspects of the present disclosure, systems, apparatuses, methods (also referred to as processes), and computer-readable media (collectively referred to herein as “systems and techniques”) are described herein that provide solutions for a multi-view based eyeball fitting for a single view gaze prediction.

Various aspects relate generally to extended reality. Some aspects more specifically relate to systems and techniques that provide solutions for gaze estimation in an XR system that are efficient in terms of computational time and power, while also maintaining accuracy in performance.

In one or more examples, the systems and techniques provide a segmentation-model based eye tracking solution that fits an ellipse (e.g., associated with a pupil of an eye of a user) on a segmentation mask by directly inferring ellipse parameters (e.g., associated with the pupil of the eye of the user) by using a machine learning model (e.g., a deep learning model) that takes an input displaying the pupil.

In some examples, the systems and technique provide a multi-view based eyeball fitting approach where a simplified multi-view based ellipse unprojection methodology is employed to find a 3D pupil disk with a correct orientation (e.g., referred to as a gaze vector). The intersection in the 3D space of the gaze vectors for different eye frames allows for the computation of the position of the eyeball center, which can be used to simplify the gaze inference.

In one or more examples, the systems and techniques provide a monocular and eyeball center-based ellipse unprojection and gaze estimation approach. During inference, the optical axis is the gaze vector with the eyeball center as the starting point, and that is determined to be the final gaze estimation for one eye.

In one or more aspects, during operation of a method for extended reality, an encoder of a machine learning model can extract features from an image including an eye of a user wearing an XR device. A decoder of the machine learning model can process (e.g., flatten) the features to generate ellipse parameters associated with a pupil of the eye of the user. One or more processors can generate, based on the ellipse parameters, an ellipse contour associated with the pupil of the eye of the user.

In one or more examples, the machine learning model can be trained based on an intersection over union (IoU) loss between the ellipse contour and a ground truth for the ellipse contour. In some examples, the machine learning model can be trained based on a mean squared error (MSE) loss between the ellipse parameters and a ground truth for the ellipse parameters. In one or more examples, the ellipse parameters can include coordinates of a center location of an ellipse representing the pupil, a width of a semi-major axis of the ellipse, a width of a semi-minor axis of the ellipse, and a tilt angle of the ellipse. In some examples, the XR device can be a head-mounted device. In one or more examples, the decoder can include a fully connected layer.

In some aspects, during operation of a method for extended reality, an XR device (e.g., an image sensor of the XR device) can obtain a first two-dimensional (2D) image at a first pose of the XR device. One or more processors can unproject a first ellipse contour on the first 2D image into a three-dimensional (3D) space to generate a first cone. The XR device (e.g., an image sensor of the XR device) can obtain a second 2D image at a second pose of the XR device. One or more processors can unproject a second ellipse contour on the second 2D image into the 3D space to generate a second cone. In one or more examples, the first ellipse contour and the second ellipse contour can be associated with a pupil of an eye of a user wearing the XR device. One or more processors can determine, based on an intersection of the first cone and the second cone, a location of a center of the pupil of the eye of the user.

In one or more examples, the first cone can include a plurality of first 3D disks. In some examples, each first 3D disk of the plurality of first 3D disks can include a respective first orientation direction and a respective second orientation direction. In one or more examples, the second cone can include a plurality of second 3D disks. In some examples, each second 3D disk of the plurality of second 3D disks can include the respective first orientation direction and the respective second orientation direction. In one or more examples, one or more processors can compare the respective first orientation directions with each other to determine a first angle difference. The one or more processors can compare the respective second orientation directions with each other to determine a second angle difference. The one or more processors can determine whether the first angle difference is less than the second angle difference. The one or more processors can determine, based on the first angle difference being less than the second angle difference, an orientation of the pupil of the eye of the user corresponds to an orientation corresponding to the respective first orientation directions.

In one or more aspects, during operation of a method for extended reality, one or more processors can determine, based on a respective normal vector for each contour of a plurality of contours, an intersection of the respective normal vectors. In one or more examples, each contour of the plurality contours can be associated with a respective gaze of a pupil of an eyeball of a user wearing an XR device. One or more processors can determine, based on the intersection of the respective normal vectors, a center of the eyeball of the user.

In one or more examples, one or more processors can unproject, an ellipse contour on a two-dimensional (2D) image, into a three-dimensional (3D) space to generate a cone. In some examples, the ellipse contour can be associated with the pupil of the eyeball of the user. In one or more examples, the cone comprises a 3D disk can include a first orientation vector and a second orientation vector.

In some examples, one or more processors can determine, based on a dot product of a vector and the first orientation vector, a first dot product value. One or more processors can determine, based on a dot product of the vector and the second orientation vector, a second dot product value. In one or more examples, the vector can radiate from the center of the eyeball to an intersection of the first orientation vector and the second orientation vector. One or more processors can determine whether the first dot product value or the second dot product value is a positive value. One or more processors can determine, based on the first dot product value being a positive value, an estimated gaze for the pupil of the eyeball corresponds to the first orientation vector.

In one or more examples, one or more processors can determine, based on an angle between a vector and the first orientation vector, a first angle. One or more processors can determine, based on an angle between the vector and the second orientation vector, a second angle. In one or more examples, the vector can radiate from the center of the eyeball to an intersection of the first orientation vector and the second orientation vector. One or more processors can determine whether the first angle is less than the second angle. One or more processors can determine, based on the first angle being less than the second angle, an estimated gaze for the pupil of the eyeball corresponds to the first orientation vector.

Particular aspects of the subject matter described in this disclosure can be implemented to realize one or more of the following potential advantages. In one or more examples, the systems and techniques can provide a benefit of providing a gaze estimation in an XR system that is accurate and efficient regarding computational time and power.

Additional aspects of the present disclosure are described in more detail below. Various aspects of the systems and techniques described herein will be discussed below with respect to the figures.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

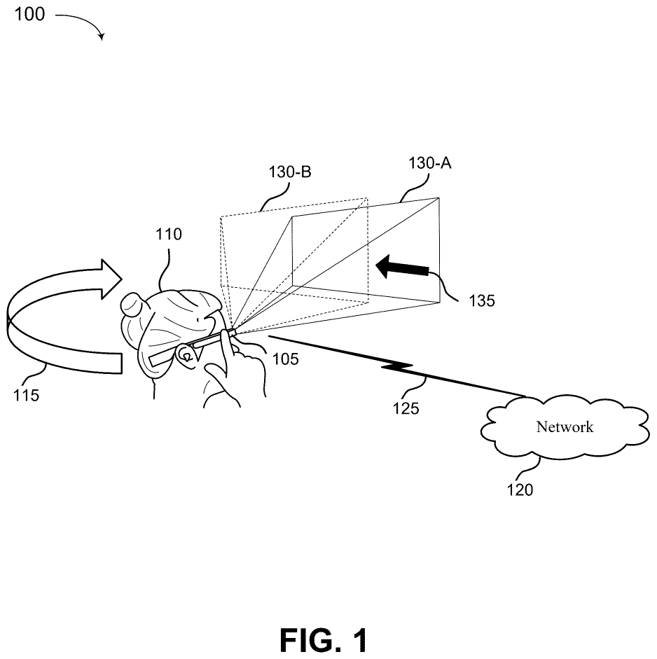

FIG. 1 illustrates an example of an extended reality system 100. As shown, the extended reality system 100 includes a device 105, a network 120, and a communication link 125. In some cases, the device 105 may be an extended reality (XR) device, which may generally implement aspects of extended reality, including virtual reality (VR), augmented reality (AR), mixed reality (MR), etc. Systems including a device 105, a network 120, or other elements in extended reality system 100 may be referred to as extended reality systems.

The device 105 may overlay virtual objects with real-world objects in a view 130. For example, the view 130 may generally refer to visual input to a user 110 via the device 105, a display generated by the device 105, a configuration of virtual objects generated by the device 105, etc. For example, view 130-A may refer to visible real-world objects (also referred to as physical objects) and visible virtual objects, overlaid on or coexisting with the real-world objects, at some initial time. View 130-B may refer to visible real-world objects and visible virtual objects, overlaid on or coexisting with the real-world objects, at some later time. Positional differences in real-world objects (e.g., and thus overlaid virtual objects) may arise from view 130-A shifting to view 130-B at 135 due to head motion 115. In another example, view 130-A may refer to a completely virtual environment or scene at the initial time and view 130-B may refer to the virtual environment or scene at the later time.

Generally, device 105 may generate, display, project, etc. virtual objects and/or a virtual environment to be viewed by a user 110 (e.g., where virtual objects and/or a portion of the virtual environment may be displayed based on user 110 head pose prediction in accordance with the techniques described herein). In some examples, the device 105 may include a transparent surface (e.g., optical glass) such that virtual objects may be displayed on the transparent surface to overlay virtual objects on real word objects viewed through the transparent surface. Additionally or alternatively, the device 105 may project virtual objects onto the real-world environment. In some cases, the device 105 may include a camera and may display both real-world objects (e.g., as frames or images captured by the camera) and virtual objects overlaid on displayed real-world objects. In various examples, device 105 may include aspects of a virtual reality headset, smart glasses, a live feed video camera, a GPU, one or more sensors (e.g., such as one or more IMUs, image sensors, microphones, etc.), one or more output devices (e.g., such as speakers, display, smart glass, etc.), etc.

In some cases, head motion 115 may include user 110 head rotations, translational head movement, etc. The device 105 may update the view 130 of the user 110 according to the head motion 115. For example, the device 105 may display view 130-A for the user 110 before the head motion 115. In some cases, after the head motion 115, the device 105 may display view 130-B to the user 110. The extended reality system (e.g., device 105) may render or update the virtual objects and/or other portions of the virtual environment for display as the view 130-A shifts to view 130-B.

In some cases, the extended reality system 100 may provide various types of virtual experiences, such as a three-dimensional (3D) gaming experiences, social media experiences, collaborative virtual environment for a group of users (e.g., including the user 110), among others. While some examples provided herein apply to 3D collaborative virtual environments, the systems and techniques described herein apply to any type of virtual environment or experience in which a virtual representation (or avatar) can be used to represent a user or participant of the virtual environment/experience.

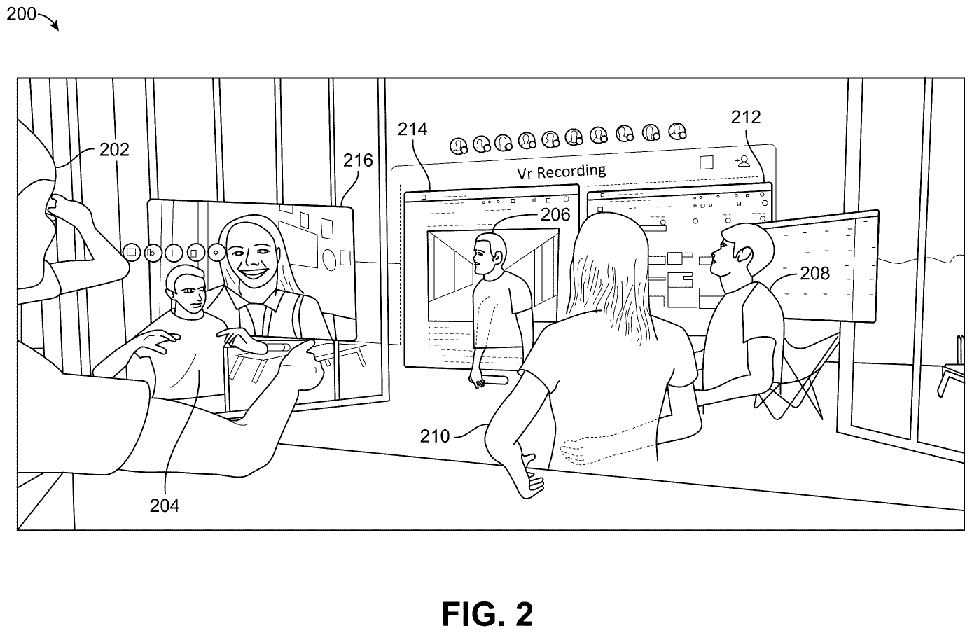

FIG. 2 is a diagram illustrating an example of a 3D collaborative virtual environment 200 in which various users interact with one another in a virtual session via virtual representations (or avatars) of the users in the virtual environment 200. The virtual representations include including a virtual representation 202 of a first user, a virtual representation 204 of a second user, a virtual representation 206 of a third user, a virtual representation 208 of a fourth user, and a virtual representation 210 of a fifth user. Other background information of the virtual environment 200 is also shown, including a virtual calendar 212, a virtual web page 214, and a virtual video conference interface 216. The users may visually, audibly, haptically, or otherwise experience the virtual environment from each user's perspective while interacting with the virtual representations of the other users. For example, the virtual environment 200 is shown from the perspective of the first user (represented by the virtual representation 202).

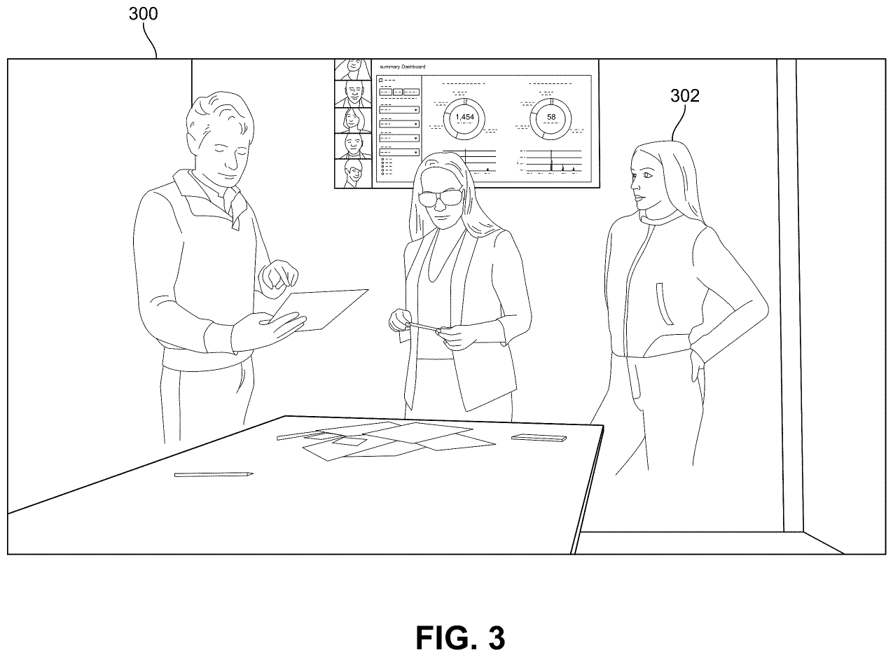

FIG. 3 is an image 300 illustrating an example of virtual representations of various users, including a virtual representation 302 of one of the users. For instance, the virtual representation 302 may be used in the 3D collaborative virtual environment 200 of FIG. 2.

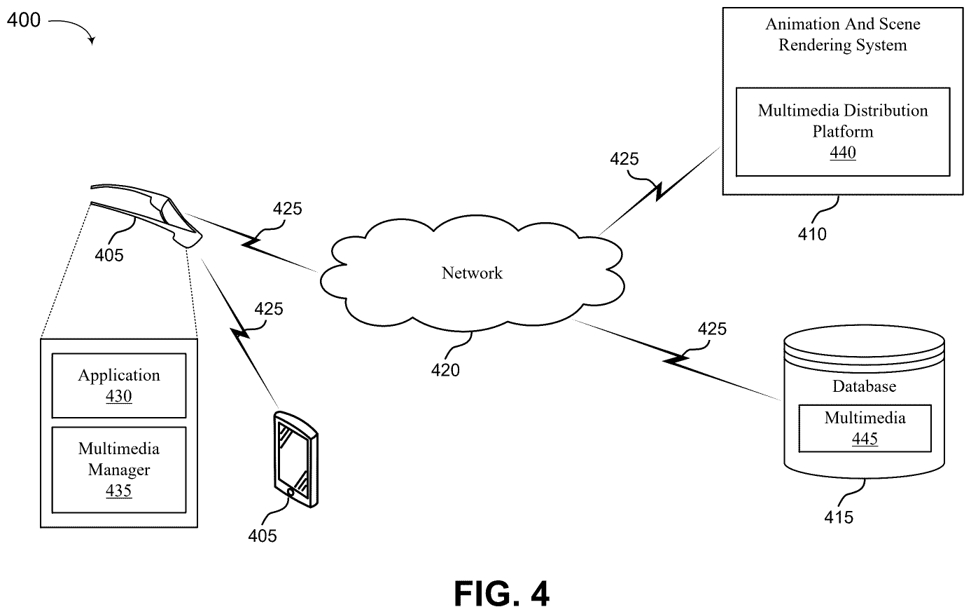

FIG. 4 is a diagram illustrating an example of a system 400 that can be used to perform the systems and techniques described herein, in accordance with aspects of the present disclosure. As shown, the system 400 includes client devices 405, an animation and scene rendering system 410, and storage 415. Although the system 400 illustrates two devices 405, a single animation and scene rendering system 410, a single storage 415, and a single network 420, the present disclosure applies to any system architecture having one or more devices 405, animation and scene rendering systems 410, storage 415, and networks 420. In some cases, the storage 415 may be part of the animation and scene rendering system 410. The devices 405, the animation and scene rendering system 410, and the storage 415 may communicate with each other and exchange information that supports generation of virtual content for XR, such as multimedia packets, multimedia data, multimedia control information, pose prediction parameters, via network 420 using communications links 425. In some cases, a portion of the techniques described herein for providing distributed generation of virtual content may be performed by one or more of the devices 405 and a portion of the techniques may be performed by the animation and scene rendering system 410, or both.

A device 405 may be an XR device (e.g., a head-mounted display (HMD), XR glasses such as virtual reality (VR) glasses, augmented reality (AR) glasses, etc.), a mobile device (e.g., a cellular phone, a smartphone, a personal digital assistant (PDA), etc.), a wireless communication device, a tablet computer, a laptop computer, and/or other device that supports various types of communication and functional features related to multimedia (e.g., transmitting, receiving, broadcasting, streaming, sinking, capturing, storing, and recording multimedia data). A device 405 may, additionally or alternatively, be referred to by those skilled in the art as a user equipment (UE), a user device, a smartphone, a Bluetooth device, a Wi-Fi device, a mobile station, a subscriber station, a mobile unit, a subscriber unit, a wireless unit, a remote unit, a mobile device, a wireless device, a wireless communications device, a remote device, an access terminal, a mobile terminal, a wireless terminal, a remote terminal, a handset, a user agent, a mobile client, a client, and/or some other suitable terminology. In some cases, the devices 405 may also be able to communicate directly with another device (e.g., using a peer-to-peer (P2P) or device-to-device (D2D) protocol, such as using sidelink communications). For example, a device 405 may be able to receive from or transmit to another device 405 variety of information, such as instructions or commands (e.g., multimedia-related information).

The devices 405 may include an application 430 and a multimedia manager 435. While the system 400 illustrates the devices 405 including both the application 430 and the multimedia manager 435, the application 430 and the multimedia manager 435 may be an optional feature for the devices 405. In some cases, the application 430 may be a multimedia-based application that can receive (e.g., download, stream, broadcast) from the animation and scene rendering systems 410, storage 415 or another device 405, or transmit (e.g., upload) multimedia data to the animation and scene rendering systems 410, the storage 415, or to another device 405 via using communications links 425.

The multimedia manager 435 may be part of a general-purpose processor, a digital signal processor (DSP), an image signal processor (ISP), a central processing unit (CPU), a graphics processing unit (GPU), a microcontroller, an application-specific integrated circuit (ASIC), a field-programmable gate array (FPGA), a discrete gate or transistor logic component, a discrete hardware component, or any combination thereof, or other programmable logic device, discrete gate or transistor logic, discrete hardware components, or any combination thereof designed to perform the functions described in the present disclosure, and/or the like. For example, the multimedia manager 435 may process multimedia (e.g., image data, video data, audio data) from and/or write multimedia data to a local memory of the device 405 or to the storage 415.

The multimedia manager 435 may also be configured to provide multimedia enhancements, multimedia restoration, multimedia analysis, multimedia compression, multimedia streaming, and multimedia synthesis, among other functionality. For example, the multimedia manager 435 may perform white balancing, cropping, scaling (e.g., multimedia compression), adjusting a resolution, multimedia stitching, color processing, multimedia filtering, spatial multimedia filtering, artifact removal, frame rate adjustments, multimedia encoding, multimedia decoding, and multimedia filtering. By further example, the multimedia manager 435 may process multimedia data to support server-based pose prediction for XR, according to the techniques described herein.

The animation and scene rendering system 410 may be a server device, such as a data server, a cloud server, a server associated with a multimedia subscription provider, proxy server, web server, application server, communications server, home server, mobile server, edge or cloud-based server, a personal computer acting as a server device, a mobile device such as a mobile phone acting as a server device, an XR device acting as a server device, a network router, any combination thereof, or other server device. The animation and scene rendering system 410 may in some cases include a multimedia distribution platform 440. In some cases, the multimedia distribution platform 440 may be a separate device or system from the animation and scene rendering system 410. The multimedia distribution platform 440 may allow the devices 405 to discover, browse, share, and download multimedia via network 420 using communications links 425, and therefore provide a digital distribution of the multimedia from the multimedia distribution platform 440. As such, a digital distribution may be a form of delivering media content such as audio, video, images, without the use of physical media but over online delivery mediums, such as the Internet. For example, the devices 405 may upload or download multimedia-related applications for streaming, downloading, uploading, processing, enhancing, etc. multimedia (e.g., images, audio, video). The animation and scene rendering system 410 or the multimedia distribution platform 440 may also transmit to the devices 405 a variety of information, such as instructions or commands (e.g., multimedia-related information) to download multimedia-related applications on the device 405.

The storage 415 may store a variety of information, such as instructions or commands (e.g., multimedia-related information). For example, the storage 415 may store multimedia 445, information from devices 405 (e.g., pose information, representation information for virtual representations or avatars of users, such as codes or features related to facial representations, body representations, hand representations, etc., and/or other information). A device 405 and/or the animation and scene rendering system 410 may retrieve the stored data from the storage 415 and/or more send data to the storage 415 via the network 420 using communication links 425. In some examples, the storage 415 may be a memory device (e.g., read only memory (ROM), random access memory (RAM), cache memory, buffer memory, etc.), a relational database (e.g., a relational database management system (RDBMS) or a Structured Query Language (SQL) database), a non-relational database, a network database, an object-oriented database, or other type of database, that stores the variety of information, such as instructions or commands (e.g., multimedia-related information).

The network 420 may provide encryption, access authorization, tracking, Internet Protocol (IP) connectivity, and other access, computation, modification, and/or functions. Examples of network 420 may include any combination of cloud networks, local area networks (LAN), wide area networks (WAN), virtual private networks (VPN), wireless networks (using 802.11, for example), cellular networks (using third generation (3G), fourth generation (4G), long-term evolved (LTE), or new radio (NR) systems (e.g., fifth generation (5G)), etc. Network 420 may include the Internet.

The communications links 425 shown in the system 400 may include uplink transmissions from the device 405 to the animation and scene rendering systems 410 and the storage 415, and/or downlink transmissions, from the animation and scene rendering systems 410 and the storage 415 to the device 405. The communications links 425 may transmit bidirectional communications and/or unidirectional communications. In some examples, the communication links 425 may be a wired connection or a wireless connection, or both. For example, the communications links 425 may include one or more connections, including but not limited to, Wi-Fi, Bluetooth, Bluetooth low-energy (BLE), cellular, Z-WAVE, 802.11, peer-to-peer, LAN, wireless local area network (WLAN), Ethernet, FireWire, fiber optic, and/or other connection types related to wireless communication systems.

In some aspects, a user of the device 405 (referred to as a first user) may be participating in a virtual session with one or more other users (including a second user of an additional device). In such examples, the animation and scene rendering systems 410 may process information received from the device 405 (e.g., received directly from the device 405, received from storage 415, etc.) to generate and/or animate a virtual representation (or avatar) for the first user. The animation and scene rendering systems 410 may compose a virtual scene that includes the virtual representation of the user and in some cases background virtual information from a perspective of the second user of the additional device. The animation and scene rendering systems 410 may transmit (e.g., via network 120) a frame of the virtual scene to the additional device. Further details regarding such aspects are provided below.

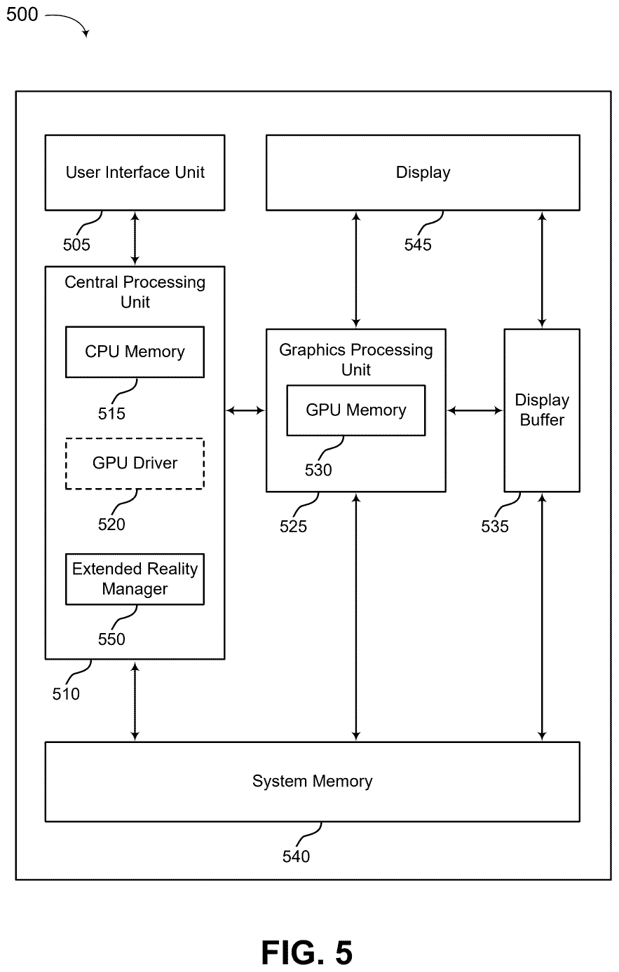

FIG. 5 is a diagram illustrating an example of a device 500. The device 500 can be implemented as a client device (e.g., device 405 of FIG. 4) or as an animation and scene rendering system (e.g., the animation and scene rendering system 410). As shown, the device 500 includes a central processing unit (CPU) 510 having CPU memory 515, a GPU 525 having GPU memory 530, a display 545, a display buffer 535 storing data associated with rendering, a user interface unit 505, and a system memory 540. For example, system memory 540 may store a GPU driver 520 (illustrated as being contained within CPU 510 as described below) having a compiler, a GPU program, a locally-compiled GPU program, and the like. User interface unit 505, CPU 510, GPU 525, system memory 540, display 545, and extended reality manager 550 may communicate with each other (e.g., using a system bus).

Examples of CPU 510 include, but are not limited to, a digital signal processor (DSP), general purpose microprocessor, application specific integrated circuit (ASIC), field programmable logic array (FPGA), or other equivalent integrated or discrete logic circuitry. Although CPU 510 and GPU 525 are illustrated as separate units in the example of FIG. 5, in some examples, CPU 510 and GPU 525 may be integrated into a single unit. CPU 510 may execute one or more software applications. Examples of the applications may include operating systems, word processors, web browsers, e-mail applications, spreadsheets, video games, audio and/or video capture, playback or editing applications, or other such applications that initiate the generation of image data to be presented via display 545. As illustrated, CPU 510 may include CPU memory 515. For example, CPU memory 515 may represent on-chip storage or memory used in executing machine or object code. CPU memory 515 may include one or more volatile or non-volatile memories or storage devices, such as flash memory, a magnetic data media, an optical storage media, etc. CPU 510 may be able to read values from or write values to CPU memory 515 more quickly than reading values from or writing values to system memory 540, which may be accessed, e.g., over a system bus.

GPU 525 may represent one or more dedicated processors for performing graphical operations. For example, GPU 525 may be a dedicated hardware unit having fixed function and programmable components for rendering graphics and executing GPU applications. GPU 525 may also include a DSP, a general purpose microprocessor, an ASIC, an FPGA, or other equivalent integrated or discrete logic circuitry. GPU 525 may be built with a highly-parallel structure that provides more efficient processing of complex graphic-related operations than CPU 510. For example, GPU 525 may include a plurality of processing elements that are configured to operate on multiple vertices or pixels in a parallel manner. The highly parallel nature of GPU 525 may allow GPU 525 to generate graphic images (e.g., graphical user interfaces and two-dimensional or three-dimensional graphics scenes) for display 545 more quickly than CPU 510.

GPU 525 may, in some instances, be integrated into a motherboard of device 500. In other instances, GPU 525 may be present on a graphics card or other device or component that is installed in a port in the motherboard of device 500 or may be otherwise incorporated within a peripheral device configured to interoperate with device 500. As illustrated, GPU 525 may include GPU memory 530. For example, GPU memory 530 may represent on-chip storage or memory used in executing machine or object code. GPU memory 530 may include one or more volatile or non-volatile memories or storage devices, such as flash memory, a magnetic data media, an optical storage media, etc. GPU 525 may be able to read values from or write values to GPU memory 530 more quickly than reading values from or writing values to system memory 540, which may be accessed, e.g., over a system bus. That is, GPU 525 may read data from and write data to GPU memory 530 without using the system bus to access off-chip memory. This operation may allow GPU 525 to operate in a more efficient manner by reducing the need for GPU 525 to read and write data via the system bus, which may experience heavy bus traffic.

Display 545 represents a unit capable of displaying video, images, text or any other type of data for consumption by a viewer. In some cases, such as when the device 500 is implemented as an animation and scene rendering system, the device 500 may not include the display 545. The display 545 may include a liquid-crystal display (LCD), a light emitting diode (LED) display, an organic LED (OLED), an active-matrix OLED (AMOLED), or the like. Display buffer 535 represents a memory or storage device dedicated to storing data for presentation of imagery, such as computer-generated graphics, still images, video frames, or the like for display 545. Display buffer 535 may represent a two-dimensional buffer that includes a plurality of storage locations. The number of storage locations within display buffer 535 may, in some cases, generally correspond to the number of pixels to be displayed on display 545. For example, if display 545 is configured to include 640×480 pixels, display buffer 535 may include 640×480 storage locations storing pixel color and intensity information, such as red, green, and blue pixel values, or other color values. Display buffer 535 may store the final pixel values for each of the pixels processed by GPU 525. Display 545 may retrieve the final pixel values from display buffer 535 and display the final image based on the pixel values stored in display buffer 535.

User interface unit 505 represents a unit with which a user may interact with or otherwise interface to communicate with other units of device 500, such as CPU 510. Examples of user interface unit 505 include, but are not limited to, a trackball, a mouse, a keyboard, and other types of input devices. User interface unit 505 may also be, or include, a touch screen and the touch screen may be incorporated as part of display 545.

System memory 540 may include one or more computer-readable storage media. Examples of system memory 540 include, but are not limited to, a random access memory (RAM), static RAM (SRAM), dynamic RAM (DRAM), a read-only memory (ROM), an electrically erasable programmable read-only memory (EEPROM), a compact disc read-only memory (CD-ROM) or other optical disc storage, magnetic disc storage, or other magnetic storage devices, flash memory, or any other medium that can be used to store desired program code in the form of instructions or data structures and that can be accessed by a computer or a processor. System memory 540 may store program modules and/or instructions that are accessible for execution by CPU 510. Additionally, system memory 540 may store user applications and application surface data associated with the applications. System memory 540 may in some cases store information for use by and/or information generated by other components of device 500. For example, system memory 540 may act as a device memory for GPU 525 and may store data to be operated on by GPU 525 as well as data resulting from operations performed by GPU 525

In some examples, system memory 540 may include instructions that cause CPU 510 or GPU 525 to perform the functions ascribed to CPU 510 or GPU 525 in aspects of the present disclosure. System memory 540 may, in some examples, be considered as a non-transitory storage medium. The term “non-transitory” should not be interpreted to mean that system memory 540 is non-movable. As one example, system memory 540 may be removed from device 500 and moved to another device. As another example, a system memory substantially similar to system memory 540 may be inserted into device 500. In certain examples, a non-transitory storage medium may store data that can, over time, change (e.g., in RAM).

System memory 540 may store a GPU driver 520 and compiler, a GPU program, and a locally-compiled GPU program. The GPU driver 520 may represent a computer program or executable code that provides an interface to access GPU 525. CPU 510 may execute the GPU driver 520 or portions thereof to interface with GPU 525 and, for this reason, GPU driver 520 is shown in the example of FIG. 5 within CPU 510. GPU driver 520 may be accessible to programs or other executables executed by CPU 510, including the GPU program stored in system memory 540. Thus, when one of the software applications executing on CPU 510 requires graphics processing, CPU 510 may provide graphics commands and graphics data to GPU 525 for rendering to display 545 (e.g., via GPU driver 520).

In some cases, the GPU program may include code written in a high level (HL) programming language, e.g., using an application programming interface (API). Examples of APIs include Open Graphics Library (“OpenGL”), DirectX, Render-Man, WebGL, or any other public or proprietary standard graphics API. The instructions may also conform to so-called heterogeneous computing libraries, such as Open-Computing Language (“OpenCL”), DirectCompute, etc. In general, an API includes a predetermined, standardized set of commands that are executed by associated hardware. API commands allow a user to instruct hardware components of a GPU 525 to execute commands without user knowledge as to the specifics of the hardware components. In order to process the graphics rendering instructions, CPU 510 may issue one or more rendering commands to GPU 525 (e.g., through GPU driver 520) to cause GPU 525 to perform some or all of the rendering of the graphics data. In some examples, the graphics data to be rendered may include a list of graphics primitives (e.g., points, lines, triangles, quadrilaterals, etc.).

The GPU program stored in system memory 540 may invoke or otherwise include one or more functions provided by GPU driver 520. CPU 510 generally executes the program in which the GPU program is embedded and, upon encountering the GPU program, passes the GPU program to GPU driver 520. CPU 510 executes GPU driver 520 in this context to process the GPU program. That is, for example, GPU driver 520 may process the GPU program by compiling the GPU program into object or machine code executable by GPU 525. This object code may be referred to as a locally-compiled GPU program. In some examples, a compiler associated with GPU driver 520 may operate in real-time or near-real-time to compile the GPU program during the execution of the program in which the GPU program is embedded. For example, the compiler generally represents a unit that reduces HL instructions defined in accordance with a HL programming language to low-level (LL) instructions of a LL programming language. After compilation, these LL instructions are capable of being executed by specific types of processors or other types of hardware, such as FPGAs, ASICs, and the like (including, but not limited to, CPU 510 and GPU 525).

In the example of FIG. 5, the compiler may receive the GPU program from CPU 510 when executing HL code that includes the GPU program. That is, a software application being executed by CPU 510 may invoke GPU driver 520 (e.g., via a graphics API) to issue one or more commands to GPU 525 for rendering one or more graphics primitives into displayable graphics images. The compiler may compile the GPU program to generate the locally-compiled GPU program that conforms to a LL programming language. The compiler may then output the locally-compiled GPU program that includes the LL instructions. In some examples, the LL instructions may be provided to GPU 525 in the form a list of drawing primitives (e.g., triangles, rectangles, etc.).

The LL instructions (e.g., which may alternatively be referred to as primitive definitions) may include vertex specifications that specify one or more vertices associated with the primitives to be rendered. The vertex specifications may include positional coordinates for each vertex and, in some instances, other attributes associated with the vertex, such as color coordinates, normal vectors, and texture coordinates. The primitive definitions may include primitive type information, scaling information, rotation information, and the like. Based on the instructions issued by the software application (e.g., the program in which the GPU program is embedded), GPU driver 520 may formulate one or more commands that specify one or more operations for GPU 525 to perform in order to render the primitive. When GPU 525 receives a command from CPU 510, it may decode the command and configure one or more processing elements to perform the specified operation and may output the rendered data to display buffer 535.

GPU 525 may receive the locally-compiled GPU program, and then, in some instances, GPU 525 renders one or more images and outputs the rendered images to display buffer 535. For example, GPU 525 may generate a number of primitives to be displayed at display 545. Primitives may include one or more of a line (including curves, splines, etc.), a point, a circle, an ellipse, a polygon (e.g., a triangle), or any other two-dimensional primitive. The term “primitive” may also refer to three-dimensional primitives, such as cubes, cylinders, sphere, cone, pyramid, torus, or the like. Generally, the term “primitive” refers to any basic geometric shape or element capable of being rendered by GPU 525 for display as an image (or frame in the context of video data) via display 545. GPU 525 may transform primitives and other attributes (e.g., that define a color, texture, lighting, camera configuration, or other aspect) of the primitives into a so-called “world space” by applying one or more model transforms (which may also be specified in the state data). Once transformed, GPU 525 may apply a view transform for the active camera (which again may also be specified in the state data defining the camera) to transform the coordinates of the primitives and lights into the camera or eye space. GPU 525 may also perform vertex shading to render the appearance of the primitives in view of any active lights. GPU 525 may perform vertex shading in one or more of the above model, world, or view space.

Once the primitives are shaded, GPU 525 may perform projections to project the image into a canonical view volume. After transforming the model from the eye space to the canonical view volume, GPU 525 may perform clipping to remove any primitives that do not at least partially reside within the canonical view volume. For example, GPU 525 may remove any primitives that are not within the frame of the camera. GPU 525 may then map the coordinates of the primitives from the view volume to the screen space, effectively reducing the three-dimensional coordinates of the primitives to the two-dimensional coordinates of the screen. Given the transformed and projected vertices defining the primitives with their associated shading data, GPU 525 may then rasterize the primitives. Generally, rasterization may refer to the task of taking an image described in a vector graphics format and converting it to a raster image (e.g., a pixelated image) for output on a video display or for storage in a bitmap file format.

A GPU 525 may include a dedicated fast bin buffer (e.g., a fast memory buffer, such as GMEM, which may be referred to by GPU memory 530). As discussed herein, a rendering surface may be divided into bins. In some cases, the bin size is determined by format (e.g., pixel color and depth information) and render target resolution divided by the total amount of GMEM. The number of bins may vary based on device 500 hardware, target resolution size, and target display format. A rendering pass may draw (e.g., render, write, etc.) pixels into GMEM (e.g., with a high bandwidth that matches the capabilities of the GPU). The GPU 525 may then resolve the GMEM (e.g., burst write blended pixel values from the GMEM, as a single layer, to a display buffer 535 or a frame buffer in system memory 540). Such may be referred to as bin-based or tile-based rendering. When all bins are complete, the driver may swap buffers and start the binning process again for a next frame.

For example, GPU 525 may implement a tile-based architecture that renders an image or rendering target by breaking the image into multiple portions, referred to as tiles or bins. The bins may be sized based on the size of GPU memory 530 (e.g., which may alternatively be referred to herein as GMEM or a cache), the resolution of display 545, the color or Z precision of the render target, etc. When implementing tile-based rendering, GPU 525 may perform a binning pass and one or more rendering passes. For example, with respect to the binning pass, GPU 525 may process an entire image and sort rasterized primitives into bins.

The device 500 may use sensor data, sensor statistics, or other data from one or more sensors. Some examples of the monitored sensors may include IMUs, eye trackers, tremor sensors, heart rate sensors, etc. In some cases, an IMU may be included in the device 500, and may measure and report a body's specific force, angular rate, and sometimes the orientation of the body, using some combination of accelerometers, gyroscopes, or magnetometers.

As shown, device 500 may include an extended reality manager 550. The extended reality manager 550 may implement aspects of extended reality, augmented reality, virtual reality, etc. In some cases, such as when the device 500 is implemented as a client device (e.g., device 405 of FIG. 4), the extended reality manager 550 may determine information associated with a user of the device and/or a physical environment in which the device 500 is located, such as facial information, body information, hand information, device pose information, audio information, etc. The device 500 may transmit the information to an animation and scene rendering system (e.g., animation and scene rendering system 410). In some cases, such as when the device 500 is implemented as an animation and scene rendering system (e.g., the animation and scene rendering system 410 of FIG. 4), the extended reality manager 550 may process the information provided by a client device as input information to generate and/or animate a virtual representation for a user of the client device.

Virtual representations (e.g., avatars) are an important component of virtual environments. A virtual representation (or avatar) is a 3D representation of a user and allows the user to interact with the virtual scene. There are different ways to represent a virtual representation of a user (e.g., an avatar) and corresponding animation data. For example, avatars may be purely synthetic or may be an accurate representation of the user (e.g., as shown by the virtual representation 302 shown in the image of FIG. 3).

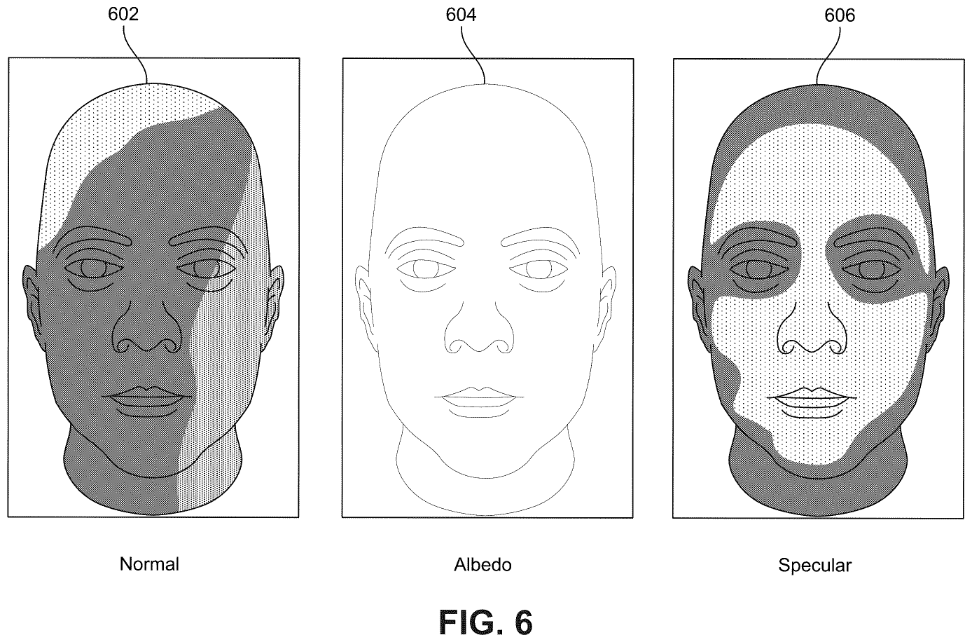

Various animation assets may be needed to model an avatar, including a mesh (e.g., a 3D mesh, such as a triangle mesh, including a plurality of vertices and line segments connected the vertices), a diffuse or albedo texture, normals specular reflection texture, and in some cases other types of textures. These various assets may be available from enrollment or offline reconstruction. FIG. 6 is a diagram illustrating an example of a normal map 602, an albedo map 604, and a specular reflection map 606.

As previously mentioned, gaze estimation in XR often aims to determine which icons or elements a user is focusing on. The gaze pose can be used to determine what item a user is focusing on (e.g., for selecting elements or icons in the virtual interface) or for foveation (e.g., to be able to optimize the rendering and blur).

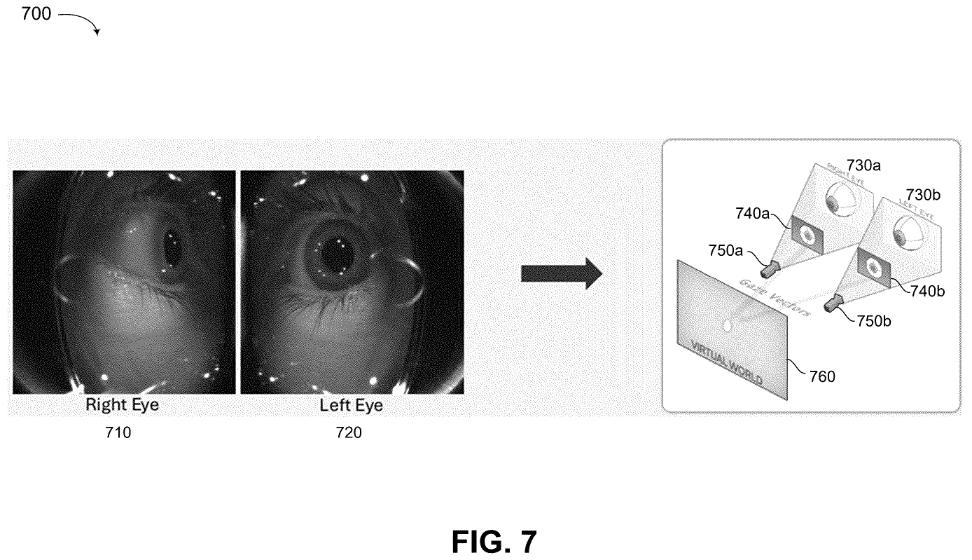

FIG. 7 shows an example XR system that performs gaze estimation. In particular, FIG. 7 is a diagram illustrating an example of an XR system 700 that performs gaze estimation. In FIG. 7, the XR system 700 includes an XR device, which may be a head-mounted device (HMD). The XR device includes image sensors 750a, 750b (e.g., infrared image sensors) that capture images 740a, 740b. Each image 740a, 740b shows a respective eye 730a, 730b (e.g., shown in example images 710, 720) of a user that is wearing the XR device, while the user is viewing a virtual world 760 shown on a display of the XR device.

As mentioned, in the XR domain, one of the key challenges is to develop a pupil-based gaze estimation system that is both accurate and efficient. To achieve high accuracy, solutions often require significant computational time and correlatively power, making them less optimal. Conversely, highly optimized solutions tend to compromise on accuracy. The challenge lies in finding a good trade-off between these factors to ensure both efficiency and precision.

Currently, most existing solutions for gaze estimation (e.g., to determine the 3D position of an eye of a user) assume a lot of information, including the pupil size and the distance between the image sensor (e.g., camera) and the center of the eyeball. Since these solutions simply fix these values, it is difficult for these systems to accurately determine the gaze estimation. There are some solutions for gaze estimation that produce high accuracy. However, these solutions are expensive because they require additional hardware, such as many light-emitting diodes (LEDs), which can increase the power consumption. Therefore, improved systems and techniques for gaze estimation in an XR system that are accurate in performance as well as efficient in terms of computational time and power can be useful.

In one or more aspects, the systems and techniques provide solutions for a multi-view based eyeball fitting for a single view gaze prediction. In one or more examples, these solutions for gaze estimation in an XR system are efficient in terms of computational time and power, while also maintaining accuracy in performance.

In one or more aspects, existing segmentation model-based eye tracking solutions fit an ellipse (e.g., associated with a pupil of an eye of a user) on a segmentation mask. To fit the ellipse, determining the contour of the segmentation mask is needed. However, these steps are power and time consuming. To optimize the existing process to determine the contour, the systems and techniques directly infer the ellipse parameters (e.g., associated with the pupil) with a machine learning model (e.g., a deep learning model) that receives an input that displays the pupil.

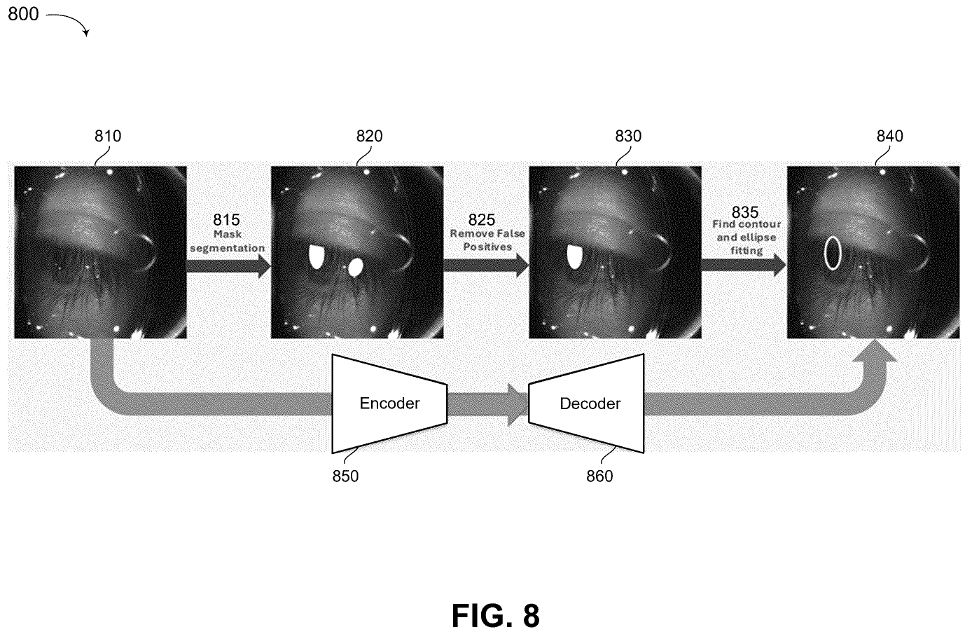

FIG. 8 shows example processes for a model-based ellipse fitting for a pupil of an eye of a user for gaze estimation. In particular, FIG. 8 is a diagram illustrating an example 800 of processes for a model-based ellipse fitting for a pupil of an eye of a user for gaze estimation.

In FIG. 8, two processes are shown, which include an existing segmentation model-based eye tracking solution (e.g., a computationally expensive process) and a more efficient disclosed process for determining the contour.

For the existing process shown in FIG. 8, an image 810 captured of an eye of a user wearing an XR device is input into a segmentation model. The segmentation model will perform segmentation 815 on the image 810 to determine pixels in the image 810 that correspond to a pupil of the eye. As such, the segmentation model will output a segmentation map 820 that includes a segmentation mask for the pixels of the pupil of the eye. However, the segmentation model may also mislabel pixels that do not correspond to the pixels of the pupil of the eye, which can cause the segmentation model to includes a false positive segmentation mask within the segmentation map 820. A post-processing phase can then be performed that can remove the false-positives 825 from the segmentation map 820 to generate a secondary segmentation map 830 that includes only the segmentation mask for the pixels of the pupil. A contour for the ellipse fitting 835 can then be determined (e.g., as shown in image 840) based on the segmentation mask for the pixels of the pupil of the secondary segmentation map 830.

For the more efficient disclosed process shown in FIG. 8, the steps shown in the existing process are reduced to make the process more time and computationally efficient. During the more efficient disclosed process of FIG. 8, an encoder 850 (e.g., a backbone neural network encoder, also referred to as a “backbone”) of a machine learning model can extract features from the image 810 including the pupil of the eye of the user wearing the XR device. A decoder 860 (e.g., an ellipse regression head) of the machine learning model can process (e.g., flatten) the features to generate ellipse parameters associated with the pupil of the eye of the user. In one or more examples, the decoder can include a single fully connected layer. In one or more examples, the ellipse parameters can include coordinates (e.g., X, Y) of the center location of an ellipse representing the pupil, a width of a semi-major axis of the ellipse, a width of a semi-minor axis of the ellipse, and a tilt angle (e.g., orientation) of the ellipse. Based on the ellipse parameters, one or more processors can generate an ellipse contour (e.g., as shown in image 840) associated with the pupil of the eye of the user.

In one or more examples, prior to operation of the more efficient disclosed process of FIG. 8, the machine learning model can be trained based on an intersection over union (IoU) loss between the ellipse contour and a ground truth for the ellipse contour. In some examples, the machine learning model can be trained based on a mean squared error (MSE) loss between the ellipse parameters and a ground truth for the ellipse parameters.

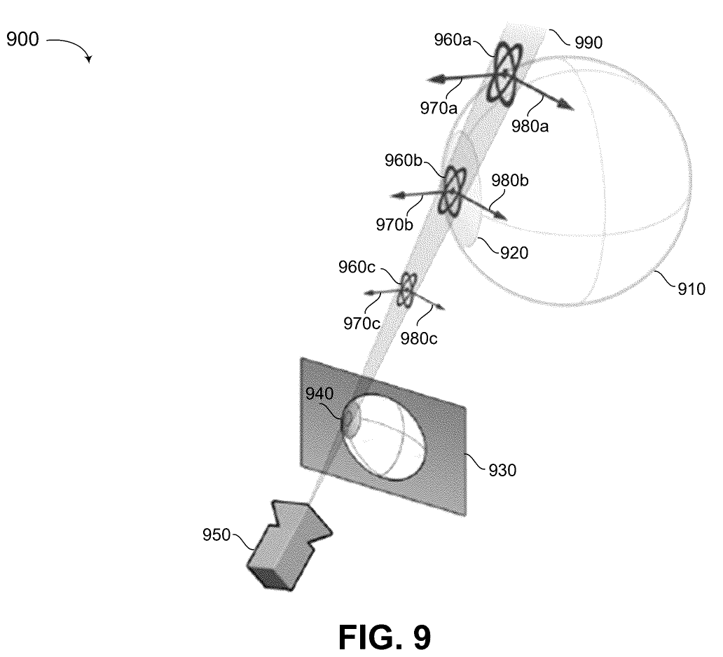

In one or more aspects, for an eyeball fitting of a user for gaze estimation, existing solutions use a monocular unprojection of the ellipse into 3D space (e.g., to find a pupil disk, such as 3D disk 960b of FIG. 9), which can lead to multiple results (e.g., since the size of the pupil is unknown and variable). These existing solutions impose the size of the pupil or the distance to the camera to solve this problem of multiple results to find one unique solution. However, this imposition leads to an imprecise gaze estimation.

FIG. 9 shows an example of an existing solution that uses a monocular-view based eyeball fitting of a user for gaze estimation. In particular, FIG. 9 is a diagram illustrating an example of a process 900 for a monocular-view based eyeball fitting of a user for gaze estimation. In FIG. 9, an image sensor 950 (e.g., an infrared image sensor), of an XR device, is shown to capture a 2D image 930. The 2D image 930 shows an ellipse contour 940 that corresponds to a pupil 920 of an eye 910 of a user that is wearing the XR device, while the user is viewing a virtual world shown on a display of the XR device. One or more processors can unproject the ellipse contour 940 on the 2D image 930 into a 3D space to generate a cone 990. The cone 990 is shown to include a plurality of 3D disks 960a, 960b, 960c. Each of the 3D disks 960a, 960b, 960c includes a respective first orientation 970a, 970b, 970c and a respective second orientation 980a, 980b, 980c. As such, as shown in FIG. 9, multiple possible solutions for the eyeball fitting are shown.

To achieve an eyeball fitting with a single accurate solution, the systems and techniques provide a simplified multi-view based ellipse unprojection to find the 3D pupil disk with the correct orientation, which is called gaze vector. The intersection in the 3D space of the gaze vectors for different eye frames allows for the computation of the position of the eyeball center, which can be used later to simplify the gaze inference.

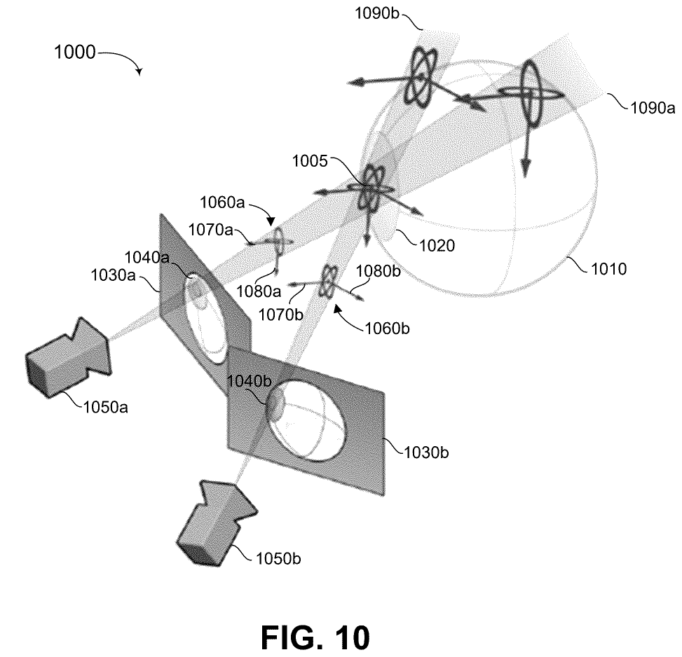

FIG. 10 shows an example process for eyeball fitting that produces a single accurate solution. In particular, FIG. 10 is a diagram illustrating an example of a process 1000 for a multi-view based eyeball fitting of a user for gaze estimation. In FIG. 10, an image sensor 1050a (e.g., an infrared image sensor) at a first pose, of an XR device, is shown to capture a 2D image 1030a. The 2D image 1030a shows an ellipse contour 1040a that corresponds to a pupil 1020 of an eye 1010 of a user that is wearing the XR device, while the user is viewing a virtual world shown on a display of the XR device. FIG. 10 also shows an image sensor 1050b (e.g., an infrared image sensor) at a second pose, of the XR device, that captures a 2D image 1030b. The 2D image 1030b shows an ellipse contour 1040b that corresponds to the pupil 1020 of the eye 1010 of the user that is wearing the XR device, while the user is viewing the virtual world shown on the display of the XR device.

One or more processors can unproject the ellipse contour 1040a on the 2D image 1030a into a 3D space to generate a cone 1090a. The cone 1090a is shown to include a plurality of 3D disks 1060a. Each of the 3D disks 1060a includes a respective first orientation direction 1070a (e.g., one of a pitch, roll, or yaw) and a respective second orientation direction 1080a (e.g., another one of a pitch, roll, or yaw), were the first orientation direction 1070a is different from the respective second orientation direction 1080a. One or more processors can also unproject the ellipse contour 1040b on the 2D image 1030b into the 3D space to generate a cone 1090b. The cone 1090b is shown to include a plurality of 3D disks 1060b. Each of the 3D disks 1060b includes a respective first orientation direction 1070b (e.g., one of a pitch, roll, or yaw) and a respective second orientation direction 1080b (e.g., another one of a pitch, roll, or yaw), were the first orientation direction 1070a is different from the respective second orientation direction 1080a. One or more processors can determine, based on an intersection 1005 of the cone 1090a and the cone 1090b, a center of the pupil 1020 of the eye 1010 of the user.

One or more processors can compare the respective first orientation directions 1070a, 1070b of the cones 1090a, 1090b with each other to determine a first angle difference. The one or more processors can compare the respective second orientation directions 1080a, 1080b of the cones 1090a, 1090b with each other to determine a second angle difference. The one or more processors can determine whether the first angle difference is less than the second angle difference. The one or more processors can determine, based on first angle difference being less than the second angle difference, an orientation of the pupil 1020 of the eye 1010 of the user corresponds to an orientation corresponding to the respective first orientation directions 1070a, 1070b.

In one or more aspects, the intersection in the 3D space of the gaze vectors for different eye frames allows for computation of the position of the eyeball center. To optimize the pupil unprojection during runtime, the systems and techniques provide a monocular and eyeball center based ellipse unprojection and gaze estimation. During inference, the optical axis is the gaze vector, using the eyeball center as a starting point. This can be the final gaze estimation for one eye.

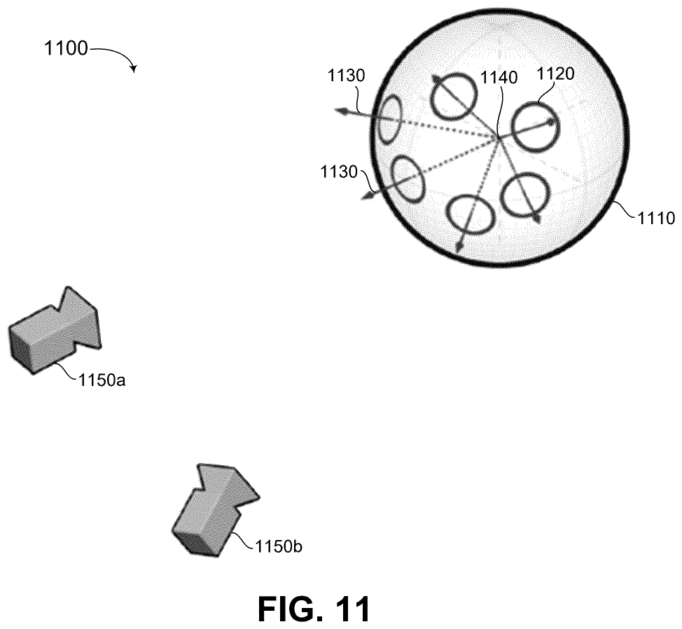

FIG. 11 shows an example process for determining a center of an eyeball of a user. In particular, FIG. 11 is a diagram illustrating an example of a process 1100 for determining a center of an eyeball 1110 of a user for gaze estimation. During operation of the process 1100, image sensors 1150a, 1150b, located at different positions, of an XR device, capture images of a user's eyeball 1110 while user is moving the eyeball 1110 around to different positions.

One or more processors can determine, based on a respective normal vector 1130 for each contour 1120 of a plurality of contours 1120, an intersection 1140 of the respective normal vectors 1130 (e.g., with a total of six normal vectors 1130 being shown in FIG. 11). In one or more examples, each contour 1120 is associated with a respective gaze of a pupil of the eyeball 1110 of the user wearing the XR device. The one or more processors can determine, based on the intersection 1140 of the respective normal vectors 1130, a center of the eyeball 1110 of the user.

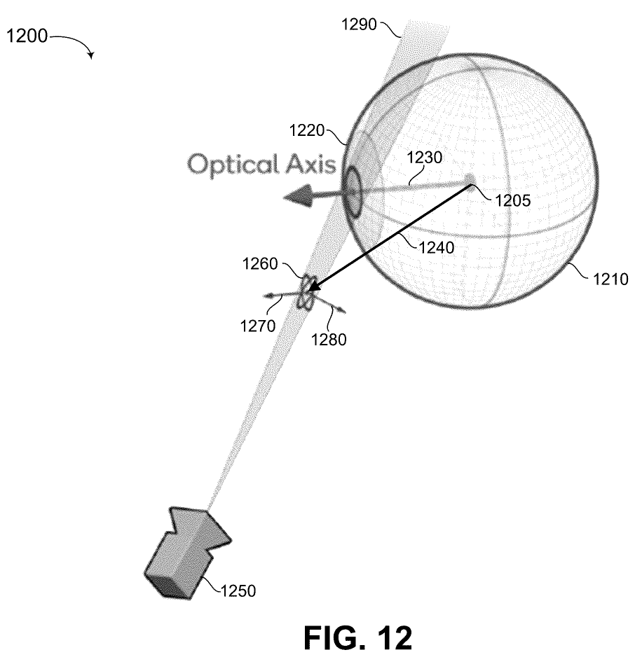

FIG. 12 shows an example process for determining the final gaze estimation for the eyeball of the user, using the eyeball center of the user. In particular, FIG. 12 is a diagram illustrating an example of a process 1200 for determining a gaze of a user. In FIG. 12, an image sensor 1250 (e.g., an infrared image sensor), of an XR device, can capture a 2D image, which includes an ellipse contour that corresponds to a pupil 1220 of an eyeball 1210 of a user that is wearing the XR device, while the user is viewing a virtual world shown on a display of the XR device. One or more processors can unproject the ellipse contour on the 2D image into a 3D space to generate a cone 1290. The cone 1290 includes a plurality of 3D disks 1260, which each include a respective first orientation vector 1270 and a respective second orientation vector 1280. An optical vector 1230 is shown to radiate from the center 1205 of the eyeball 1210 through the center of the pupil 1220. A vector 1240 is shown to radiate from the center 1205 of the eyeball 1210 to an intersection of a first orientation vector 1270 and a corresponding second orientation vector 1280.

One or more processors can determine, based on a dot product of the vector 1240 and a first orientation vector 1270, a first dot product value. The one or more processors can determine, based on a dot product of the vector 1240 and a second orientation vector 1280, a second dot product value. The one or more processors can determine whether the first dot product value or the second dot product value is a positive value. The one or more processors can determine, based on the first dot product value being a positive value, an estimated gaze for the pupil 1220 of the eyeball 1210 corresponds to the first orientation vector 1270.

One or more processors can determine, based on an angle between of the vector 1240 and the first orientation vector 1270, a first angle. The one or more processors can determine, based on an angle between the vector 1240 and the second orientation vector 1280, a second angle. The one or more processors can determine whether the first angle is less than the second angle. The one or more processors can determine, based on the first angle being less than the second angle, an estimated gaze for the pupil 1220 of the eyeball 1210 corresponds to the first orientation vector 1270.

As shown above, eyeball fitting based on a pupil may be performed using multiple image sensors (e.g., image sensors 1050a, 1050b of FIG. 10, image sensors 1150a, 1150b of FIG. 11, etc.). While multi-sensor systems can offer relatively high accuracy by allowing efficient triangulation of the eye with multiple views of each eye, each additional sensor can increase power consumption and cost. In some cases, a single sensor (e.g., image sensor) per eye solution for monitoring the gaze of a pupil may be useful to help reduce costs and power consumption while limiting compromises in accuracy.

To help improve accuracy for pupil gaze monitoring using a single sensor, it may be useful to calibrate the single sensor by triangulating the gaze pose of the eyeball in a manner similar to that performed in multi-sensor systems. Once calibrated, the movements of the pupil and gaze may then be updated by the single sensor. In some cases, to provide additional views of the eyeball and pupil for triangulating the gaze pose, it may be useful to leverage existing interpupillary distance (IPD) adjustment mechanisms.

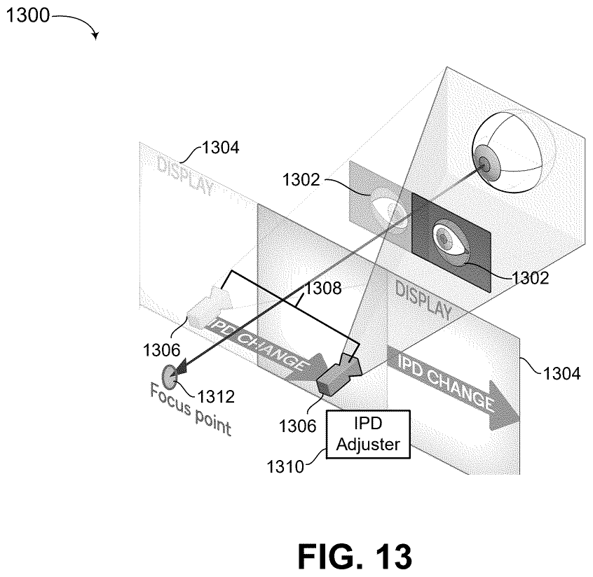

FIG. 13 illustrates interpupillary distance (IPD) adjustment 1300, in accordance with aspects of the present disclosure. The IPD may be a distance between a center (e.g., pupils) of a person's eyes 1302 and the IPD can vary widely between people. As the displays 1304 (and cameras 1306 (e.g., eye tracking cameras)) of a head-mounted XR device are typically placed close to the eyes 1302, a distance 1308 (e.g., lens spacing, IPD distance) between and/or location of the displays 1304 may be adjusted to provide a clearer view to the user. In some cases, adjusting the distance 1308 of the displays 1304 also adjusts the distance 1308 of the cameras 1306 to provide a more consistent view of the eyes 1302. This distance 1308 adjustment may be performed using a motorized IPD adjuster 1310. The IPD adjuster 1310 may be software controlled and may change the distance 1308 of the displays 1304 based on a distance and/or direction indication, for example, from a driver or other software executing on the XR device. Changing the distance 1308 between the displays 1304 (and cameras 1306) may be performed without changing the focus point 1312 (e.g., by adjusting the locations of both displays 1304 concurrently) to avoid causing excessive movement of the pupil and eyes 1302.

In some cases, as changing the distance 1308 between the displays 1304 can also change the distance between the cameras 1306, adjusting the IPD may be used to provide additional views of the eyes 1302 and pupils. For example, a first image of the eyes may be captured by the cameras 1306 at a first IPD distance. The first image may be captured while the user is looking at a displayed target point (e.g., focus point 1312). The distance between the cameras 1306 may be changed, for example, by a known amount using the IPD adjuster 1310 via software, and a second image of the eyes may be captured by the cameras 1306. The IPD distance 1308 change may be performed in a way that a user is still able to properly focus on a target point (e.g., focus point 1312) on the screen. As the first image and second image are captured from different camera poses, the first image and second image may be used to triangulate the gaze pose of the eyes 1302 in a manner similar to that performed in multi-sensor systems, as discussed above. Changing the distance 1308 between the displays 1304 to triangulate the gaze pose of the eyes 1302 may be performed during a calibration process, or at any time where the user is focusing on a target point.

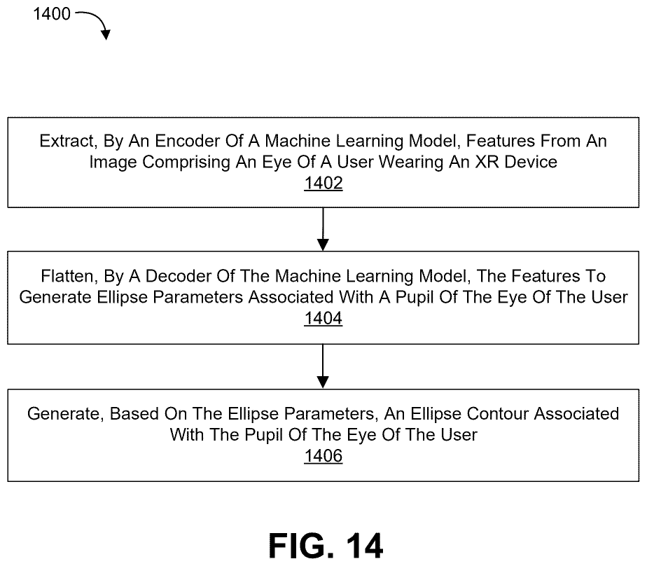

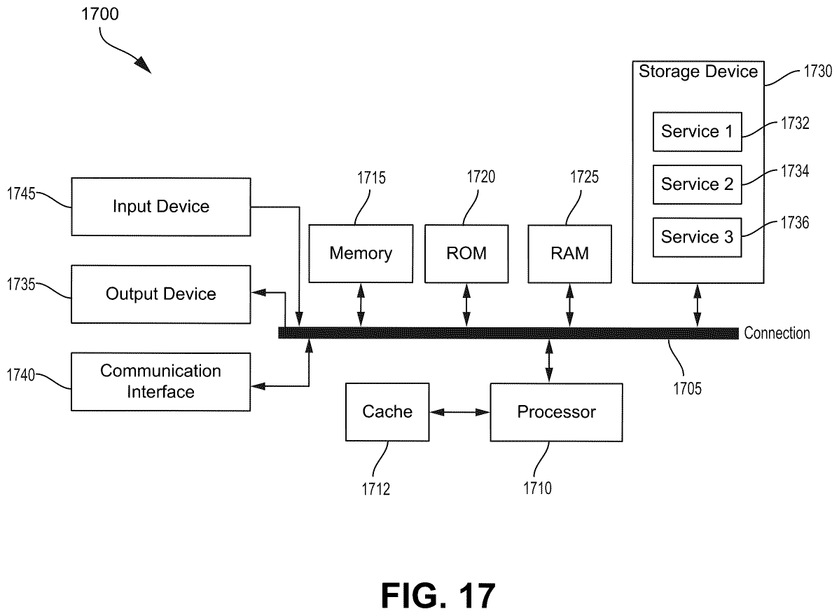

FIG. 14 is a flow chart illustrating an example of a process 1400 for extended reality. The process 1400 can be performed by a computing device (e.g., a computing device or computing system 1700 of FIG. 17) or by a component or system (e.g., a chipset, one or more processors central processing units (CPUs), digital signal processors (DSPs), graphics processing units (GPUs), any combination thereof, and/or other type of processor(s), or other component or system) of the computing device. The computing device or component thereof can be an XR device (e.g., a head-mounted device (HMD) or glasses) or part of the XR device, such as the device 105 of FIG. 1, the client device 405 of FIG. 4, the device 500 of FIG. 5, or other XR device. The operations of the process 1400 may be implemented as software components that are executed and run on one or more processors (e.g., processor 1710 of FIG. 17, or other processor(s)). Further, the transmission and reception of signals by the computing device in the process 1400 may be enabled, for example, by one or more antennas and/or one or more transceivers (e.g., wireless transceiver(s)).

At block 1402, the computing device (or component thereof) can extract, using an encoder (e.g., the encoder 850 of FIG. 8) of a machine learning model, features from an image (e.g., the image 810) including an eye of a user wearing an XR device. In some aspects, the machine learning model is trained based on an intersection over union (IoU) loss between the ellipse contour and a ground truth for the ellipse contour. Additionally or alternatively, in some cases, the machine learning model is trained based on a mean squared error (MSE) loss between the ellipse parameters and a ground truth for the ellipse parameters.

At block 1404, the computing device (or component thereof) can process, using a decoder (e.g., the decoder 860 of FIG. 8) of the machine learning model, the features to generate ellipse parameters associated with a pupil of the eye of the user. In some aspects, the decoder includes a fully connected layer (e.g., the decoder may include only the fully connected layer and no other layers, or in some case may include other layers in addition to the fully connected layer). In some aspects, the ellipse parameters include coordinates of a center location of an ellipse representing the pupil, a width of a semi-major axis of the ellipse, a width of a semi-minor axis of the ellipse, a tilt angle of the ellipse, any combination thereof, and/or other parameters.

At block 1406, the computing device (or component thereof) can generate, based on the ellipse parameters, an ellipse contour associated with the pupil of the eye of the user (e.g., the contour for the pupil output by the decoder 860, as shown in image 840 of FIG. 8).

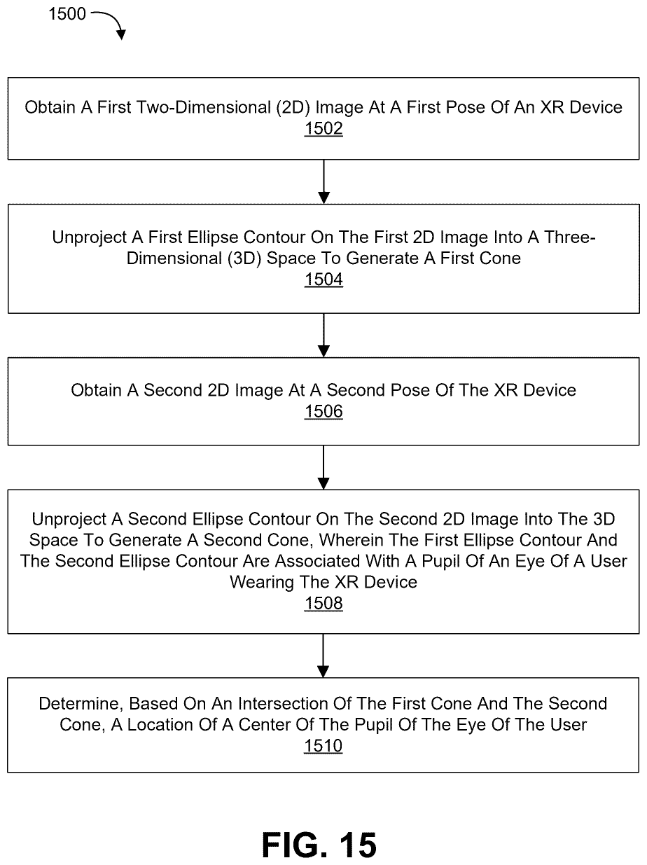

FIG. 15 is a flow chart illustrating an example of a process 1500 for extended reality. The process 1500 can be performed by a computing device (e.g., a computing device or computing system 1700 of FIG. 17) or by a component or system (e.g., a chipset, one or more processors central processing units (CPUs), digital signal processors (DSPs), graphics processing units (GPUs), any combination thereof, and/or other type of processor(s), or other component or system) of the computing device. The computing device or component thereof can be an XR device (e.g., a head-mounted device (HMD) or glasses) or part of the XR device, such as the device 105 of FIG. 1, the client device 405 of FIG. 4, the device 500 of FIG. 5, or other XR device. The operations of the process 1500 may be implemented as software components that are executed and run on one or more processors (e.g., processor 1710 of FIG. 17, or other processor(s)). Further, the transmission and reception of signals by the computing device in the process 1500 may be enabled, for example, by one or more antennas and/or one or more transceivers (e.g., wireless transceiver(s)). In some cases, the process 1500 can be performed following completion of the process 1400 (e.g., to generate one or more ellipse contours for one or more pupils). In some cases, the process 1500 can be performed independently with respect to the process 1400.

At block 1502, the computing device (or component thereof) can obtain a first two-dimensional (2D) image (e.g., 2D image 1030a of FIG. 10) at a first pose of an XR device.

At block 1504, the computing device (or component thereof) can unproject a first ellipse contour (e.g., ellipse contour 1040a of FIG. 10) on the first 2D image into a three-dimensional (3D) space to generate a first cone (e.g., cone 1090a of FIG. 10). The first ellipse contour is associated with a pupil of an eye of a user wearing the XR device. In some aspects, the first cone includes a plurality of first 3D disks (e.g., the plurality of 3D disks 1060a of FIG. 10). For instance, each first 3D disk of the plurality of first 3D disks includes a respective first orientation direction and a respective second orientation direction, where the respective first orientation direction is different from the respective second orientation direction.

At block 1506, the computing device (or component thereof) can obtain a second 2D image (e.g., 2D image 1030b of FIG. 10) at a second pose of the XR device. In some cases, the first 2D image and second 2D image are captured by a single imaging device (e.g., image sensors 750a, 750b of FIG. 7, image sensor 950 of FIG. 9, image sensors 1050a, 1050b of FIG. 10, image sensors 1150a, 1150b of FIG. 11, image sensor 1250 of FIG. 12, cameras 1306 of FIG. 13, etc.). In some examples, the computing device (or component thereof) may obtain the first 2D image with the imaging device at a first location, move the imaging device to a second location, and obtain the second 2D image at the second location. In some cases, the imaging device is moved as a part of an interpupillary distance adjustment (IPD) (e.g., IPD adjuster 1310 of FIG. 13).

At block 1508, the computing device (or component thereof) can unproject a second ellipse contour (e.g., ellipse contour 1040b of FIG. 10) on the second 2D image into the 3D space to generate a second cone (e.g., cone 1090a of FIG. 10). The second ellipse contour is also associated with the pupil of the eye of the user wearing the XR device. In some aspects, the second cone includes a plurality of second 3D disks (e.g., the plurality of 3D disks 1060b of FIG. 10). For example, each second 3D disk of the plurality of second 3D disks includes the respective first orientation direction and the respective second orientation direction, where the respective first orientation direction is different from the respective second orientation direction.

At block 1510, the computing device (or component thereof) can determine, based on an intersection of the first cone and the second cone, a location of a center of the pupil of the eye of the user. For instance, as described herein, the computing device (or component thereof) can determine, based on an intersection 1005 of the cone 1090a and the cone 1090b of FIG. 10, a center of the pupil 1020 of the eye 1010 of the user. The intersection in the 3D space of the gaze vectors for the different perspectives or views of the first and second 2D images allows for computation of the position of the eyeball center.

In some aspects, the computing device (or component thereof) can compare the respective first orientation directions with each other to determine a first angle difference, The computing device (or component thereof) can compare the respective second orientation directions with each other to determine a second angle difference. The computing device (or component thereof) can determine whether the first angle difference is less than the second angle difference. The computing device (or component thereof) can determine, based on the first angle difference being less than the second angle difference, an orientation of the pupil of the eye of the user corresponds to an orientation corresponding to the respective first orientation directions.

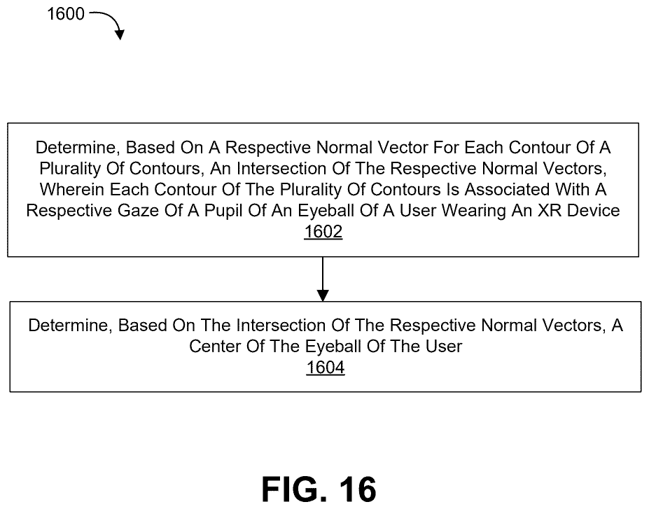

FIG. 16 is a flow chart illustrating an example of a process 1600 for extended reality. The process 1600 can be performed by a computing device (e.g., a computing device or computing system 1700 of FIG. 17) or by a component or system (e.g., a chipset, one or more processors central processing units (CPUs), digital signal processors (DSPs), graphics processing units (GPUs), any combination thereof, and/or other type of processor(s), or other component or system) of the computing device. The computing device or component thereof can be an XR device (e.g., a head-mounted device (HMD) or glasses) or part of the XR device, such as the device 105 of FIG. 1, the client device 405 of FIG. 4, the device 500 of FIG. 5, or other XR device. The operations of the process 1600 may be implemented as software components that are executed and run on one or more processors (e.g., processor 1710 of FIG. 17, or other processor(s)). Further, the transmission and reception of signals by the computing device in the process 1600 may be enabled, for example, by one or more antennas and/or one or more transceivers (e.g., wireless transceiver(s)). In some cases, the process 1600 can be performed following completion of the process 1400 (and/or in conjunction with at least a portion of the process 1400, such as to determine one or more ellipse contours) and the process 1500. In some cases, the process 1600 can be performed independently with respect to the process 1400 and/or the process 1500.

At block 1602, the computing device (or component thereof) can determine, based on a respective normal vector for each contour of a plurality of contours, an intersection of the respective normal vectors (e.g., the normal vectors 1130 of FIG. 11). Each contour of the plurality contours is associated with a respective gaze of a pupil of an eyeball of a user wearing an XR device. In some cases, the plurality of contours are determined based on a plurality of images. In some examples, the plurality of images are captured by a single imaging device (e.g., image sensors 750a, 750b of FIG. 7, image sensor 950 of FIG. 9, image sensors 1050a, 1050b of FIG. 10, image sensors 1150a, 1150b of FIG. 11, image sensor 1250 of FIG. 12, cameras 1306 of FIG. 13, etc.). In some cases, the computing device (or component thereof) may obtain a first image, of the plurality of images, with the imaging device at a first location, move the imaging device to a second location, and obtain a second image, of the plurality of images, at the second location. In some examples, the imaging device is moved as a part of an interpupillary distance adjustment (IPD) (e.g., IPD adjuster 1310 of FIG. 13).

At block 1604, the computing device (or component thereof) can determine, based on the intersection of the respective normal vectors, a center of the eyeball of the user.

In some aspects, the computing device (or component thereof) can unproject, an ellipse contour on a two-dimensional (2D) image, into a three-dimensional (3D) space to generate a cone. The ellipse contour is associated with the pupil of the eyeball of the user. In some cases, the cone includes a 3D disk including a first orientation vector and a second orientation vector.

In some aspects, the computing device (or component thereof) can determine, based on a dot product of a vector and the first orientation vector, a first dot product value. The computing device (or component thereof) can determine, based on a dot product of the vector and the second orientation vector, a second dot product value. The vector radiates from the center of the eyeball to an intersection of the first orientation vector and the second orientation vector (e.g., the optical vector 1230 of FIG. 12 radiating from the center 1205 of the eyeball 1210 through the center of the pupil 1220). The computing device (or component thereof) can determine whether the first dot product value or the second dot product value is a positive value. The computing device (or component thereof) can determine, based on the first dot product value being a positive value, an estimated gaze for the pupil of the eyeball corresponds to the first orientation vector.

In some aspects, the computing device (or component thereof) can determine, based on an angle between a vector and the first orientation vector, a first angle. The computing device (or component thereof) can determine, based on an angle between the vector and the second orientation vector, a second angle. The vector radiates from the center of the eyeball to an intersection of the first orientation vector and the second orientation vector (e.g., the optical vector 1230 of FIG. 12 radiating from the center 1205 of the eyeball 1210 through the center of the pupil 1220). The computing device (or component thereof) can determine whether the first angle is less than the second angle. The computing device (or component thereof) can determine, based on the first angle being less than the second angle, an estimated gaze for the pupil of the eyeball corresponds to the first orientation vector.

In some cases, the computing device of process 1400, process 1500, and process 1600 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of process 1400, process 1500, and process 1600 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1400, process 1500, and process 1600 is each illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1400, process 1500, and process 1600 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 17 is a block diagram illustrating an example of a computing system 1700, which may be employed for a multi-view based eyeball fitting for a single view gaze prediction. In particular, FIG. 17 illustrates an example of computing system 1700, which can be for example any computing device making up internal computing system, a remote computing system, a camera, or any component thereof in which the components of the system are in communication with each other using connection 1705. Connection 1705 can be a physical connection using a bus, or a direct connection into processor 1710, such as in a chipset architecture. Connection 1705 can also be a virtual connection, networked connection, or logical connection.

In some aspects, computing system 1700 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1700 includes at least one processing unit (CPU or processor) 1710 and connection 1705 that communicatively couples various system components including system memory 1715, such as read-only memory (ROM) 1720 and random access memory (RAM) 1725 to processor 1710. Computing system 1700 can include a cache 1712 of high-speed memory connected directly with, in close proximity to, or integrated as part of processor 1710.

Processor 1710 can include any general purpose processor and a hardware service or software service, such as services 1732, 1734, and 1736 stored in storage device 1730, configured to control processor 1710 as well as a special-purpose processor where software instructions are incorporated into the actual processor design. Processor 1710 may essentially be a completely self-contained computing system, containing multiple cores or processors, a bus, memory controller, cache, etc. A multi-core processor may be symmetric or asymmetric.

To enable user interaction, computing system 1700 includes an input device 1745, which can represent any number of input mechanisms, such as a microphone for speech, a touch-sensitive screen for gesture or graphical input, keyboard, mouse, motion input, speech, etc. Computing system 1700 can also include output device 1735, which can be one or more of a number of output mechanisms. In some instances, multimodal systems can enable a user to provide multiple types of input/output to communicate with computing system 1700.

Computing system 1700 can include communications interface 1740, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1740 may also include one or more range sensors (e.g., LiDAR sensors, laser range finders, RF radars, ultrasonic sensors, and infrared (IR) sensors) configured to collect data and provide measurements to processor 1710, whereby processor 1710 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1740 may also include one or more receivers or transceivers that are used to determine a location of the computing system 1700 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1730 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1 ) cache, Level 2 (L2 ) cache, Level 3 (L3 ) cache, Level 4 (L4 ) cache, Level 5 (L5 ) cache, or other (L#) cache), resistive random-access memory (RRAM/ReRAM), phase change memory (PCM), spin transfer torque RAM (STT-RAM), another memory chip or cartridge, and/or a combination thereof.

The storage device 1730 can include software services, servers, services, etc., that when the code that defines such software is executed by the processor 1710, it causes the system to perform a function. In some aspects, a hardware service that performs a particular function can include the software component stored in a computer-readable medium in connection with the necessary hardware components, such as processor 1710, connection 1705, output device 1735, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like)

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. An apparatus for extended reality (XR), the apparatus comprising: at least one memory; and at least one processor coupled to the at least one memory and configured to: extract, using an encoder of a machine learning model, features from an image comprising an eye of a user wearing an XR device; process, using a decoder of the machine learning model, the features to generate ellipse parameters associated with a pupil of the eye of the user; and generate, based on the ellipse parameters, an ellipse contour associated with the pupil of the eye of the user.

Aspect 2. The apparatus of Aspect 1, wherein the machine learning model is trained based on an intersection over union (IoU) loss between the ellipse contour and a ground truth for the ellipse contour.

Aspect 3. The apparatus of any of Aspects 1 or 2, wherein the machine learning model is trained based on a mean squared error (MSE) loss between the ellipse parameters and a ground truth for the ellipse parameters.

Aspect 4. The apparatus of any of Aspects 1 to 3, wherein the ellipse parameters comprise coordinates of a center location of an ellipse representing the pupil, a width of a semi-major axis of the ellipse, a width of a semi-minor axis of the ellipse, and a tilt angle of the ellipse.

Aspect 5. The apparatus of any of Aspects 1 to 4, wherein XR device is a head-mounted device.

Aspect 6. The apparatus of any of Aspects 1 to 5, wherein the decoder includes a fully connected layer.

Aspect 7. An apparatus for extended reality (XR), the apparatus comprising: at least one memory; and at least one processor coupled to the at least one memory and configured to: obtain a first two-dimensional (2D) image at a first pose of an XR device; unproject a first ellipse contour on the first 2D image into a three-dimensional (3D) space to generate a first cone; obtain a second 2D image at a second pose of the XR device; unproject a second ellipse contour on the second 2D image into the 3D space to generate a second cone, wherein the first ellipse contour and the second ellipse contour are associated with a pupil of an eye of a user wearing the XR device; and determine, based on an intersection of the first cone and the second cone, a location of a center of the pupil of the eye of the user.

Aspect 8. The apparatus of Aspect 7, wherein the first cone comprises a plurality of first 3D disks, and wherein each first 3D disk of the plurality of first 3D disks comprises a respective first orientation direction and a respective second orientation direction.

Aspect 9. The apparatus of Aspect 8, wherein the second cone comprises a plurality of second 3D disks, and wherein each second 3D disk of the plurality of second 3D disks comprises the respective first orientation direction and the respective second orientation direction.

Aspect 10. The apparatus of Aspect 9, wherein the at least one processor is configured to: compare the respective first orientation directions with each other to determine a first angle difference; compare the respective second orientation directions with each other to determine a second angle difference; determine whether the first angle difference is less than the second angle difference; and determine, based on the first angle difference being less than the second angle difference, an orientation of the pupil of the eye of the user corresponds to an orientation corresponding to the respective first orientation directions.

Aspect 11.The apparatus of any of Aspects 7 to 10, wherein the first 2D image and second 2D image are captured by a single imaging device.

Aspect 12.The apparatus of Aspect 11, wherein the at least one processor is configured to: obtain the first 2D image with the imaging device at a first location; move the imaging device to a second location; and obtain the second 2D image at the second location.

Aspect 13.The apparatus of Aspect 12, wherein the imaging device is moved as a part of an interpupillary distance adjustment.

Aspect 14. An apparatus for extended reality (XR), the apparatus comprising: at least one memory; and at least one processor coupled to the at least one memory and configured to: determine, based on a respective normal vector for each contour of a plurality of contours, an intersection of the respective normal vectors, wherein each contour of the plurality contours is associated with a respective gaze of a pupil of an eyeball of a user wearing an XR device; and determine, based on the intersection of the respective normal vectors, a center of the eyeball of the user.

Aspect 15. The apparatus of Aspect 14, wherein the at least one processor is configured to unproject, an ellipse contour on a two-dimensional (2D) image, into a three-dimensional (3D) space to generate a cone, wherein the ellipse contour is associated with the pupil of the eyeball of the user.

Aspect 16. The apparatus of Aspect 15, wherein the cone comprises a 3D disk comprising a first orientation vector and a second orientation vector.

Aspect 17. The apparatus of Aspect 16, wherein the at least one processor is configured to: determine, based on a dot product of a vector and the first orientation vector, a first dot product value; determine, based on a dot product of the vector and the second orientation vector, a second dot product value, wherein the vector radiates from the center of the eyeball to an intersection of the first orientation vector and the second orientation vector; determine whether the first dot product value or the second dot product value is a positive value; and determine, based on the first dot product value being a positive value, an estimated gaze for the pupil of the eyeball corresponds to the first orientation vector.

Aspect 18. The apparatus of any of Aspects 16 or 17, wherein the at least one processor is configured to: determine, based on an angle between a vector and the first orientation vector, a first angle; determine, based on an angle between the vector and the second orientation vector, a second angle, wherein the vector radiates from the center of the eyeball to an intersection of the first orientation vector and the second orientation vector; determine whether the first angle is less than the second angle; and determine, based on the first angle being less than the second angle, an estimated gaze for the pupil of the eyeball corresponds to the first orientation vector.

Aspect 19.The apparatus of any of Aspects 14 to 18, wherein the plurality of contours are determined based on a plurality of images, and wherein the plurality of images are captured by a single imaging device.

Aspect 20.The apparatus of Aspect 19, wherein the at least one processor is configured to: obtain a first image, of the plurality of images, with the imaging device at a first location; move the imaging device to a second location; and obtain a second image, of the plurality of images, at the second location.

Aspect 21.The apparatus of Aspect 20, wherein the imaging device is moved as a part of an interpupillary distance adjustment.

Aspect 22. A method for extended reality (XR), the method comprising: extracting, by an encoder of a machine learning model, features from an image comprising an eye of a user wearing an XR device; processing, by a decoder of the machine learning model, the features to generate ellipse parameters associated with a pupil of the eye of the user; and generating, based on the ellipse parameters, an ellipse contour associated with the pupil of the eye of the user.

Aspect 23. The method of Aspect 22, further comprising training the machine learning model based on an intersection over union (IoU) loss between the ellipse contour and a ground truth for the ellipse contour.

Aspect 24. The method of any of Aspects 22 or 23, further comprising training the machine learning model based on a mean squared error (MSE) loss between the ellipse parameters and a ground truth for the ellipse parameters.

Aspect 25. The method of any of Aspects 22 to 24, wherein the ellipse parameters comprise coordinates of a center location of an ellipse representing the pupil, a width of a semi-major axis of the ellipse, a width of a semi-minor axis of the ellipse, and a tilt angle of the ellipse.

Aspect 26. The method of any of Aspects 22 to 25, wherein XR device is a head-mounted device.

Aspect 27. The method of any of Aspects 22 to 26, wherein the decoder includes a fully connected layer.

Aspect 28. A method for extended reality (XR), the method comprising: obtaining a first two-dimensional (2D) image at a first pose of an XR device; unprojecting a first ellipse contour on the first 2D image into a three-dimensional (3D) space to generate a first cone; obtaining a second 2D image at a second pose of the XR device; unprojecting a second ellipse contour on the second 2D image into the 3D space to generate a second cone, wherein the first ellipse contour and the second ellipse contour are associated with a pupil of an eye of a user wearing the XR device; and determining, based on an intersection of the first cone and the second cone, a location of a center of the pupil of the eye of the user.

Aspect 29. The method of Aspect 28, wherein the first cone comprises a plurality of first 3D disks, and wherein each first 3D disk of the plurality of first 3D disks comprises a respective first orientation direction and a respective second orientation direction.

Aspect 30. The method of Aspect 29, wherein the second cone comprises a plurality of second 3D disks, and wherein each second 3D disk of the plurality of second 3D disks comprises the respective first orientation direction and the respective second orientation direction.

Aspect 31. The method of Aspect 30, further comprising: comparing the respective first orientation directions with each other to determine a first angle difference; comparing the respective second orientation directions with each other to determine a second angle difference; determining whether the first angle difference is less than the second angle difference; and determining, based on the first angle difference being less than the second angle difference, an orientation of the pupil of the eye of the user corresponds to an orientation corresponding to the respective first orientation directions.

Aspect 32.The method of any of Aspects 28 to 31, wherein the first 2D image and second 2D image are captured by a single imaging device.

Aspect 33.The method of Aspect 32, further comprising: obtaining the first 2D image with the imaging device at a first location; moving the imaging device to a second location; and obtaining the second 2D image at the second location.

Aspect 34.The method of Aspect 33, wherein the imaging device is moved as a part of an interpupillary distance adjustment.

Aspect 35. A method for extended reality (XR), the method comprising: determining, based on a respective normal vector for each contour of a plurality of contours, an intersection of the respective normal vectors, wherein each contour of the plurality contours is associated with a respective gaze of a pupil of an eyeball of a user wearing an XR device; and determining, based on the intersection of the respective normal vectors, a center of the eyeball of the user.

Aspect 36. The method of Aspect 26, further comprising unprojecting, an ellipse contour on a two-dimensional (2D) image, into a three-dimensional (3D) space to generate a cone, wherein the ellipse contour is associated with the pupil of the eyeball of the user.

Aspect 37. The method of Aspect 27, wherein the cone comprises a 3D disk comprising a first orientation vector and a second orientation vector.

Aspect 38. The method of Aspect 28, further comprising: determining, based on a dot product of a vector and the first orientation vector, a first dot product value; determining, based on a dot product of the vector and the second orientation vector, a second dot product value, wherein the vector radiates from the center of the eyeball to an intersection of the first orientation vector and the second orientation vector; determining whether the first dot product value or the second dot product value is a positive value; and determining, based on the first dot product value being a positive value, an estimated gaze for the pupil of the eyeball corresponds to the first orientation vector.

Aspect 39. The method of any of Aspects 28 or 29, further comprising: determining, based on an angle between a vector and the first orientation vector, a first angle; determining, based on an angle between the vector and the second orientation vector, a second angle, wherein the vector radiates from the center of the eyeball to an intersection of the first orientation vector and the second orientation vector; determining whether the first angle is less than the second angle; and determining, based on the first angle being less than the second angle, an estimated gaze for the pupil of the eyeball corresponds to the first orientation vector.

Aspect 40.The method of any of Aspects 35 to 39, wherein the plurality of contours are determined based on a plurality of images, and wherein the plurality of images are captured by a single imaging device.

Aspect 41.The method of Aspect 40, further comprising: obtaining a first image, of the plurality of images, with the imaging device at a first location; moving the imaging device to a second location; and obtaining a second image, of the plurality of images, at the second location.

Aspect 42.The method of Aspect 41, wherein the imaging device is moved as a part of an interpupillary distance adjustment.

Aspect 43. A non-transitory computer-readable medium having stored thereon instructions that, when executed by at least one processor, cause the at least one processor to perform operations according to any of Aspects 22 to 27.

Aspect 44. An apparatus for extended reality (XR), the apparatus including one or more means for performing operations according to any of Aspects 22 to 27.

Aspect 45. A non-transitory computer-readable medium having stored thereon instructions that, when executed by at least one processor, cause the at least one processor to perform operations according to any of Aspects 28 to 34.

Aspect 46. An apparatus for extended reality (XR), the apparatus including one or more means for performing operations according to any of Aspects 28 to 34.

Aspect 47. A non-transitory computer-readable medium having stored thereon instructions that, when executed by at least one processor, cause the at least one processor to perform operations according to any of Aspects 35 to 42.

Aspect 48. An apparatus for extended reality (XR), the apparatus including one or more means for performing operations according to any of Aspects 35 to 42.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus for extended reality (XR), the apparatus comprising:
at least one memory; and
at least one processor coupled to the at least one memory and configured to:
extract, using an encoder of a machine learning model, features from an image comprising an eye of a user wearing an XR device;
process, using a decoder of the machine learning model, the features to generate ellipse parameters associated with a pupil of the eye of the user; and
generate, based on the ellipse parameters, an ellipse contour associated with the pupil of the eye of the user.

2. The apparatus of claim 1, wherein the machine learning model is trained based on an intersection over union (IoU) loss between the ellipse contour and a ground truth for the ellipse contour.

3. The apparatus of claim 1, wherein the machine learning model is trained based on a mean squared error (MSE) loss between the ellipse parameters and a ground truth for the ellipse parameters.

4. The apparatus of claim 1, wherein the ellipse parameters comprise coordinates of a center location of an ellipse representing the pupil, a width of a semi-major axis of the ellipse, a width of a semi-minor axis of the ellipse, and a tilt angle of the ellipse.

5. The apparatus of claim 1, wherein XR device is a head-mounted device.

6. The apparatus of claim 1, wherein the decoder includes a fully connected layer.

7. An apparatus for extended reality (XR), the apparatus comprising:
at least one memory; and
at least one processor coupled to the at least one memory and configured to:
obtain a first two-dimensional (2D) image at a first pose of an XR device;
unproject a first ellipse contour on the first 2D image into a three-dimensional (3D) space to generate a first cone;
obtain a second 2D image at a second pose of the XR device;
unproject a second ellipse contour on the second 2D image into the 3D space to generate a second cone, wherein the first ellipse contour and the second ellipse contour are associated with a pupil of an eye of a user wearing the XR device; and
determine, based on an intersection of the first cone and the second cone, a location of a center of the pupil of the eye of the user.

8. The apparatus of claim 7, wherein the first cone comprises a plurality of first 3D disks, and wherein each first 3D disk of the plurality of first 3D disks comprises a respective first orientation direction and a respective second orientation direction.

9. The apparatus of claim 8, wherein the second cone comprises a plurality of second 3D disks, and wherein each second 3D disk of the plurality of second 3D disks comprises the respective first orientation direction and the respective second orientation direction.

10. The apparatus of claim 9, wherein the at least one processor is configured to:
compare the respective first orientation directions with each other to determine a first angle difference;
compare the respective second orientation directions with each other to determine a second angle difference;
determine whether the first angle difference is less than the second angle difference; and
determine, based on the first angle difference being less than the second angle difference, an orientation of the pupil of the eye of the user corresponds to an orientation corresponding to the respective first orientation directions.

11. The apparatus of claim 7, wherein the first 2D image and second 2D image are captured by a single imaging device.

12. The apparatus of claim 11, wherein the at least one processor is configured to:
obtain the first 2D image with the imaging device at a first location;
move the imaging device to a second location; and
obtain the second 2D image at the second location.

13. The apparatus of claim 12, wherein the imaging device is moved as a part of an interpupillary distance adjustment.

14. An apparatus for extended reality (XR), the apparatus comprising:
at least one memory; and
at least one processor coupled to the at least one memory and configured to:
determine, based on a respective normal vector for each contour of a plurality of contours, an intersection of the respective normal vectors, wherein each contour of the plurality contours is associated with a respective gaze of a pupil of an eyeball of a user wearing an XR device; and
determine, based on the intersection of the respective normal vectors, a center of the eyeball of the user.

15. The apparatus of claim 14, wherein the at least one processor is configured to unproject, an ellipse contour on a two-dimensional (2D) image, into a three-dimensional (3D) space to generate a cone, wherein the ellipse contour is associated with the pupil of the eyeball of the user.

16. The apparatus of claim 15, wherein the cone comprises a 3D disk comprising a first orientation vector and a second orientation vector.

17. The apparatus of claim 16, wherein the at least one processor is configured to:
determine, based on a dot product of a vector and the first orientation vector, a first dot product value;
determine, based on a dot product of the vector and the second orientation vector, a second dot product value, wherein the vector radiates from the center of the eyeball to an intersection of the first orientation vector and the second orientation vector;
determine whether the first dot product value or the second dot product value is a positive value; and
determine, based on the first dot product value being a positive value, an estimated gaze for the pupil of the eyeball corresponds to the first orientation vector.

18. The apparatus of claim 16, wherein the at least one processor is configured to:
determine, based on an angle between a vector and the first orientation vector, a first angle;
determine, based on an angle between the vector and the second orientation vector, a second angle, wherein the vector radiates from the center of the eyeball to an intersection of the first orientation vector and the second orientation vector;
determine whether the first angle is less than the second angle; and
determine, based on the first angle being less than the second angle, an estimated gaze for the pupil of the eyeball corresponds to the first orientation vector.

19. The apparatus of claim 14, wherein the plurality of contours are determined based on a plurality of images, and wherein the plurality of images are captured by a single imaging device.

20. The apparatus of claim 19, wherein the at least one processor is configured to:
obtain a first image, of the plurality of images, with the imaging device at a first location;
move the imaging device to a second location; and
obtain a second image, of the plurality of images, at the second location.
